(19) United States
(12) Patent Application Publication
(10) Pub. No.: US 2015/0090156 A1
(43) Pub. Date: Apr. 2, 2015

(54) ADHESIVES THAT INCLUDE PLASTICIZED STARCH DERIVATIVES AND METHODS AND ARTICLES RELATING THERETO

(71) Applicant: Celanese Acetate LLC, Irving, TX (US)

(72) Inventors: Michael Combs, Pembroke, VA (US); Wendy Bisset, Eggleston, VA (US); Lizbeth Milward, Blacksburg, VA (US); Mehrsa Raeiszadeh, Blacksburg, VA (US)

(73) Assignee: Celanese Acetate LLC, Irving, TX (US)

(21) Appl. No.: 14/499,497

(22) Filed: Sep. 29, 2014

Related U.S. Application Data
(60) Provisional application No. 61/884,337, filed on Sep. 30, 2013.
(60) Provisional application No. 62/011,201, filed on Jun. 12, 2014.

(51) Int. Cl. C09J 103/06; C08K 5/01; C08K 5/07; C08K 5/11; C08K 5/1565; C08K 5/134; C08K 5/52; C08K 5/05; C08K 5/1535; C09J 101/12; C08K 5/06

(52) U.S. Cl. CPC C09J 103/06; C09J 101/12; C08K 5/01; C08K 5/07; C08K 5/11; C08K 5/06; C08K 5/134; C08K 5/52; C08K 5/05; C08K 5/1535; C08K 5/1565; C09J 2403/00; C09J 2401/00
USPC 106/145.5; 106/207.3; 106/207.2; 106/162.9; 524/51

(57) ABSTRACT

The adhesive compositions that include starch derivatives, plasticizers, optionally cellulose derivatives, and optionally other additives. By tailoring the composition and concentration of these components, hot melt adhesive compositions, hot melt pressure sensitive adhesive compositions, and pressure sensitive adhesives have been produced. Further, these adhesive compositions may be useful in articles including diapers, laminates, repositionable advertisements, and many more.

### BACKGROUND

The exemplary embodiments described herein relate to hot melt and pressure-sensitive adhesive compositions that comprise plasticized starch derivatives optionally compounded with cellulose derivatives and/or other additives, and methods and articles relating thereto.

Adhesives are useful in several applications from arts and crafts (e.g., hot glue sticks) to consumer products (e.g., cigarette seam line adhesives and repositionable, adhesive paper products like sticky-notes) to packaging (e.g., shipping box and cereal box adhesives).

There are several types of adhesives including pressure sensitive adhesives (“PSA”), pressure sensitive hot melt adhesive (“PSHMA”), hot melt adhesives (“HMA”), and drying adhesives. As used herein, a pressure sensitive adhesive refers to an adhesive compositions that is tacky at room temperature to the extent that a 4 mil (the unit “mil” refers to a thousandth of an inch) coated paper backing sticks to the adhesive composition with no pressure applied (i.e., with only the weight of the 4 mil coated paper backing). In some instances, a pressure sensitive adhesive may be a viscous paste or putty. As used herein, a pressure sensitive hot melt adhesive refers to an adhesive composition that sticks to a 4 mil coated paper backing at room temperature with weight applied by a roller of 4.5 pounds or less. A pressure sensitive hot melt adhesive may be tacky or non-tacky at room temperature. As used herein, a hot melt adhesive refer to an adhesive compositions that sticks to a 4 mil coated paper backing when heated and does not stick to the 4 mil coated paper backing at room temperature with weight applied by a roller of 4.5 pounds or less. As used herein, a drying adhesive refers to an adhesive composition that is liquid at room temperature and often includes a solvent that evaporates to increase the adhesive bond between the adhesive and a surface. Drying adhesives may, for example, be in the form of high viscosity pastes or low viscosity fluids (e.g., spray adhesives).

Common PSA, HMPSA, and HMA use synthetic polymers (e.g., ethylene vinyl acetate copolymers, polysiloxanes, and polyurethanes) in combination with additives like tackifiers, waxes, and fillers in varying concentrations and compositions for desired PSA, HMPSA, or HMA. However formulated, these adhesives generally may have poor environmental degradability and generally interfere with recycling processes. For example, in removing labels from glass bottles and repulping of paper products, a caustic bath is used to degrade the paper product. Adhesives with synthetic polymers like ethylene vinyl acetate copolymers, polysiloxanes, and polyurethanes generally stay intact when exposed to caustic baths. Therefore, in some instances, additional steps, often costly, labor-intensive steps, are included in such recycling processes to account for the use of these adhesives. Further, in some instances, depending on the amount of adhesive used and local recycling capabilities, the article may be non-recyclable.

Given the push to develop environmentally-friendly adhesives that are biodegradable and derived from renewable resources, starch derivatives have become more widely explored for adhesive properties. However, most starch-based adhesives are drying adhesives that include significant concentrations of water or other solvents. Starch-based PSA, HMPSA, or HMA have seen little success. Therefore, starch and starch derivatives are often used as fillers rather than major components of PSA, HMPSA, or HMA. Further, when used in such adhesive compositions, the starch and starch derivatives have high amylose contents and use non-volatile plasticizers, both of which reduce the ability of the adhesive to degrade, either chemically or mechanically, over time.

Accordingly, PSA, HMPSA, and HMA having increased starch derivative concentrations to increase environmental degradability and compatibility with recycling processes may be useful.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIGS. 1A-E provide illustrations of nonlimiting examples of article configurations according to at least some embodiments described herein.

### DETAILED DESCRIPTION

The exemplary embodiments described herein relate to PSA, HMPSA, and HMA that comprise plasticized starch derivatives, and methods and articles relating thereto.

In some embodiments, the adhesive compositions described herein include plasticizers, starch derivatives, optionally cellulose derivatives, and optionally additives. The use of volatile and semi-volatile plasticizers, as well as, starches and starch derivatives containing a low percentage of amylose (e.g., less than about 30% by weight of the starch) have been found to provide both tunable and surprisingly strong adhesives in some compositions. The discovery of adhesive compositions with low amylose content starch derivatives was quite surprising given the plurality of research conducted on starch-based adhesives and plasticized starch compositions.

Further, it has been discovered that starch derivatives may be useful in producing several types of adhesives, including PSA, HMPSA, or HMA, which expands the applicability of these bio-derived and degradable adhesive compositions. As used herein, the term “bio-derived” refers to a compound or portion thereof originating from a biological source or produced via a biological reaction. The bio-derived portion of the adhesive compositions described herein refers to the mass percent that is bio-derived. For example, a starch acetate produced from starch and a petroleum-derived acetic acid would be less than 100% bio-derived. Whereas a 100% bio-derived starch acetate may be produced, for example, from acylation of starch with a bio-derived acid chloride (e.g., produced by reacting thionyl chloride with bio-derived acetic acid, which may be produced via a number of methods including those involving microbial fermentation). In some instances, the adhesive compositions described herein may be 100% bio-derived with the use of bio-derived plasticizers and starch derivatives that use bio-derived acids in the derivatization process.

Additionally, caustic baths in recycling processes would decompose the starch derivatives and cellulose derivatives to starch and cellulose, respectively, which is the product of caustic bath paper repulping or label removal. Therefore, adhesives that include starch derivatives, cellulose derivatives, or both would minimally, if at all, impact caustic bath recycling processes.

Additionally, the ability to tailor the adhesive strength of at least some embodiments of the adhesive compositions to be comparable to that of EVA-based adhesives was unexpected. It has long been held that petroleum-based adhesives are superior in adhesive strength to bio-derived adhesives. The plasticized starch derivative adhesives described herein advantageously provide for less expensive adhesive compositions that are bio-derived and biodegradable as compared to the petroleum-derived adhesives while maintaining adhesive properties.

In addition, the adhesive strength of at least some embodiments of the adhesive compositions have been shown to increase with the addition of fillers like glass beads, nanocrystalline cellulose (“NCC”), cellulose nano fibrils, and unfunctionalized starch. The inclusion of such fillers in other adhesive compositions is used to decrease the amount of polymer in the adhesive composition, which in turn decreases the cost of the adhesive composition. However, the addition of the fillers decreases in adhesive strength of the other adhesive compositions. Therefore, in other adhesive compositions, a balance is reached between cost and performance. Unexpectedly, fillers have increased the adhesive strength of the adhesive compositions described herein.

Furthermore, the adhesive compositions described herein may be food-grade by using starch derivatives, plasticizers, and optionally cellulose derivatives (e.g., starch acetate, triacetin, and cellulose acetate) that are approved for use in conjunction with food applications (e.g., food packaging) and other applications with an increased risk for oral ingestion by consumer (e.g., cigarette adhesives). As used herein, the term “food-grade” refers to a material that has been approved for contacting (directly or indirectly) food, which may be classified as based on the material's conformity to the requirements of the United States Pharmacopeia (“USP-grade”), the National Formulary (“NF-grade”), and/or the Food Chemicals Codex (“FCC-grade”).

Additionally, in some embodiments, the adhesive compositions described herein may be suitable for high-speed coating/adhering methods because there is little to no dry time associated with their application and the melt flow properties of the adhesive composition can be tailored for fast coating processes. This is especially advantageous for laminate coatings and label application. By contrast, emulsion formulations that are used for adhesives and laminate coatings require drying through hundreds of feet of ovens to achieve the desired final product. At least some of the adhesive compositions described herein suitable for similar applications, on the other hand, need only cool to achieve a comparable final product. In some instances, a brief heating may be performed to drive off plasticizer, but because the adhesive compositions described herein include volatile to semi-volatile plasticizers, the time and distance associated with heating would be significantly less. Reducing the time and distance associated with heating would advantageously reduce energy costs and machinery footprint.

It should be noted that when “about” is used in reference to a number in a numerical list, the term “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

### I. Adhesive Compositions

The adhesive compositions described herein may include plasticizers, starch derivatives, optionally cellulose derivatives, and optionally additives. The type and other properties of the adhesive compositions described herein may depend the composition of each component in the adhesive composition and their relative concentrations.

In some embodiments, the plasticizers may be present in adhesive compositions described herein in an amount ranging from a lower limit of about 5%, 10%, 15%, 30%, 40%, 50%, or 60% by weight of the adhesive composition to an upper limit of about 90%, 80%, 70%, 60%, or 50% by weight of the adhesive composition, wherein the amount may range from any lower limit to any upper limit and encompass any subset therebetween (e.g., about 20% to about 65%). In some embodiments, the adhesive compositions described herein may be highly-plasticized and comprise starch derivatives and plasticizers, wherein the plasticizers are present in an amount of about 40% or greater by weight of the adhesive composition.

In some embodiments, the adhesive composition may be HMA as defined herein. In some instances, starch derivative HMA described herein may include plasticizers in an amount of about 5% to about 60% by weight of the adhesive composition, including subsets therebetween. Non-tacky HMA may be in the form of a sheet, pellets, sticks, molded products, and the like. It should be noted that the term “sheet” should not be interpreted to be limited in thickness and encompasses films, layers, and the like. In some embodiments, such starch derivative HMA may be melted and used for melt casting a laminate onto a substrate. In some instances, the adhesive compositions may be disposed on a substrate like a plastic or paper label, heated, and applied to a second substrate like a glass or plastic bottle.

In some embodiments, the adhesive composition may be HMPSA as defined herein. In some instances, starch derivative HMPSA described herein may include plasticizers in an amount of about 30% to about 75% by weight of the adhesive composition, including subsets therebetween. In some instances, such adhesive compositions may be tacky or non-tacky at room temperature. In some instances, heat may be used to enhance the tackiness of such an adhesive composition. Such starch derivative HMPSA may be used in repositionable articles like sticky-notes, labels, window or glass films, and repositionable tabs on diapers. In some instances, such an adhesive composition may increase in strength over time, which may allow for initial repositioning of the article (e.g., an advertisement or logo on a wall, window, or vehicle) and then strengthening of the adhesive to be permanent to semi-permanent.

In some embodiments, the adhesive composition may be PSA as defined herein. In some instances, starch derivative PSA described herein may include plasticizer in an amount of about 40% to about 90% by weight of the adhesive composition. Such starch derivative PSA may be in the form of a paste, a putty, and the like.

It should be noted that the concentration of plasticizers in the different types of adhesive compositions overlap because the properties and, consequently, the type of the adhesive composition depend on, inter alia, the composition of the plasticizer, the composition of the starch derivatives, and the composition and concentration of the other optional components in the adhesive composition. In some instances, the concentration of plasticizers relative to the classification of the adhesive composition may fall outside the preferred ranges described herein. It has been observed that with the same starch derivative and concentration of plasticizer, but different plasticizer compositions, different types of adhesive compositions can be produced. One skilled in the art with the benefit of this disclosure should recognize that the preferred ranges described herein for the plasticizers relative to the type of adhesive composition are not limiting, and, in some instances, a plasticizer concentration may fall outside these preferred ranges to produce an adhesive composition of a specific type (i.e., PSA, HMPSA, or HMA).

Plasticizers suitable for use in conjunction with the adhesives described herein may, in some embodiments, include, but are not limited to,

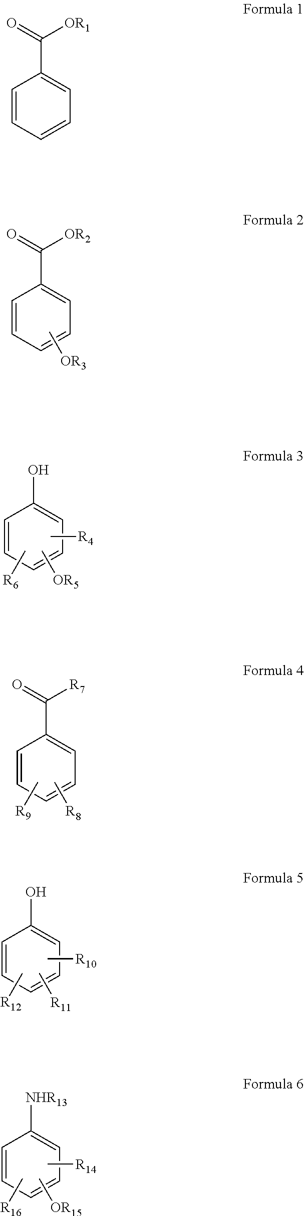

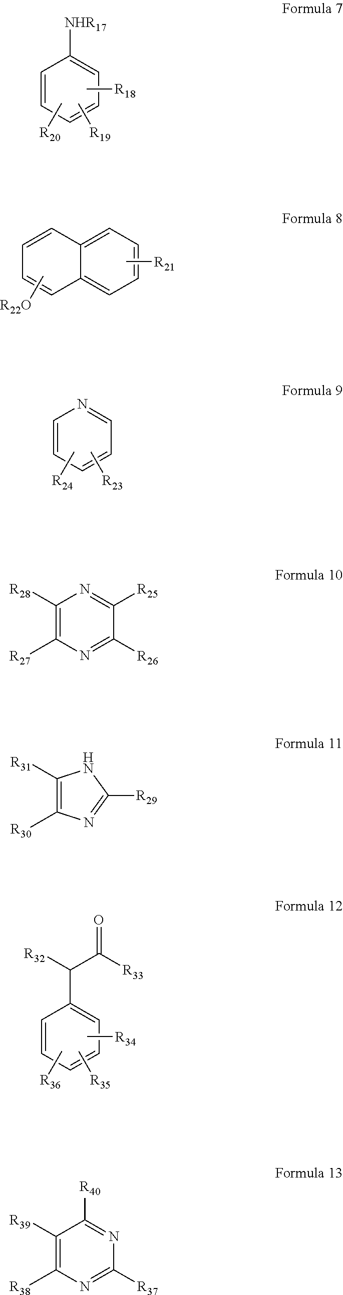

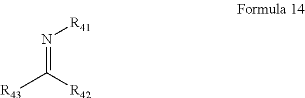

Formula 1 wherein R1 is H, C₁-C₄ alkyl, aryl, or C₁-C₄ alkyl aryl; Formula 2 wherein R2 is H, C₁-C₄ alkyl, aryl, or C₁-C₄ alkyl aryl and R3 is H, C₁-C₄ alkyl, aryl, C₁-C₄ alkyl aryl, acyl, or C₁-C₄ alkyl acyl; Formula 3 wherein R4 and R6 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R5 is H, C₁-C₄ alkyl, aryl, C₁-C₄ alkyl aryl, acyl, or C₁-C₄ alkyl acyl; Formula 4 wherein R7 is H, C₁-C₄ alkyl, aryl, C₁-C₄ alkyl aryl, OH, C₁-C₄ alkoxy, amine, or C₁-C₄ alkyl amine and R8 and R9 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 5 wherein R10, R11, and R12 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 6 wherein R13 is H, C₁-C₄ alkyl, aryl, or C₁-C₄ alkyl aryl, R14 and R16 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide, and R15 is H, C₁-C₄ alkyl, aryl, C₁-C₄ alkyl aryl, acyl, or C₁-C₄ alkyl acyl; Formula 7 wherein R17 is H or C₁-C₄ alkyl and R18, R19, and R20 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 8 wherein R21 is H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R22 is H, C₁-C₄ alkyl, aryl, C₁-C₄ alkyl aryl, acyl, C₁-C₄ alkyl acyl, amine, or C₁-C₄ alkyl amine; Formula 9 wherein R23 and R24 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 10 wherein R25, R26, R27, and R28 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 11 wherein R29, R30, and R31 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 12 wherein R32 is H, C₁-C₄ alkyl, aryl, C₁-C₄ alkyl aryl, R33 is H, C₁-C₄ alkyl, aryl, C₁-C₄ alkyl aryl, OH, C₁-C₄ alkoxy, acyl, C₁-C₄ alkyl acyl, amine, or C₁-C₄ alkyl amine, and R34, R35, and R36 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 13 wherein R37, R38, R39, and R40 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 14 wherein R41 is H, C₁-C₄ alkyl, aryl, C₁-C₄ alkyl aryl, OH, or C₁-C₄ alkoxy and R42 and R43 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; triazine (1,2,3, 1,2,4, or 1,3,5) with R substituents from each of the cyclic carbons or cyclic nitrogens that are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; triazole (1,2,3 or 1,2,4) with R substituents from each of the cyclic carbons or cyclic nitrogens that are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; pyrrole with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; piperidine with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; piperazine with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; R44HN—R45-NHR46 where R44 and R46 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R45 is C₁-C₁₀ alkyl; and combinations thereof. As used herein, “alkyl” refers to a substituent with C and H that may be linear or branched (e.g., t-butyl) and saturated or unsaturated. As used herein, “aryl” refers to an aromatic ring that may include phenyl, naphthyl, and aromatic rings with heteroatoms.

Examples of plasticizers suitable for use in conjunction with the adhesives described herein may, in some embodiments, include, but are not limited to, triacetin, trimethyl phosphate, triethyl phosphate, tributyl phosphate, triphenyl phosphate, triethyl citrate, acetyl trimethyl citrate, acetyl triethyl citrate, acetyl tributyl citrate, tributyl-o-acetyl citrate, dibutyl phthalate, diaryl phthalate, diethyl phthalate, dimethyl phthalate, di-2-methoxyethyl phthalate, di-octyl phthalate (and isomers), dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, polycaprolactone, glycerin, glycerin esters, diacetin, polyethylene glycol, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, propylene carbonate, C₁-C₂₀ dicarboxylic acid esters, dimethyl adipate (and other dialkyl esters), di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkyl lactones (e.g., γ-valerolactone), alkylphosphate esters, aryl phosphate esters, phospholipids, aromas (including some described herein, e.g., eugenol, cinnamyl alcohol, camphor, methoxy hydroxy acetophenone (acetovanillone), vanillin, and ethylvanillin), 2-phenoxyethanol, glycol ethers, glycol esters, glycol ester ethers, polyglycol ethers, polyglycol esters, ethylene glycol ethers, propylene glycol ethers, ethylene glycol esters (e.g., ethylene glycol diacetate), propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybeonzoate, methyl-4-hydroxybeonzoate, ethyl-4-hydroxybeonzoate, benzyl-4-hydroxybeonzoate, butylated hydroxytoluene, butylated hydroxyanisol, sorbitol, xylitol, ethylene diamine, piperidine, piperazine, hexamethylene diamine, triazine, triazole, pyrrole, and the like, any derivative thereof, and any combination thereof.

Additional examples of plasticizers suitable for use in conjunction with the adhesives described herein may, in some embodiments, be nonionic surfactants that include, but are not limited to, polysorbates (e.g., TWEEN®20 or TWEEN®80, available from SigmaAldrich), sorbitan esters (e.g., SPAN® products available from SigmaAldrich), polyethoxylated aromatic hydrocarbons (e.g., TRITON® products available from SigmaAldrich), polyethoxylated fatty acids, polyethoxylated fatty alcohols (e.g., BRIJ® products available from SigmaAldrich), fluorosurfactants, glucosides, and other nonionic surfactants with hydrocarbon tails (e.g., C₆-C₂₂ alkyl groups) and hydrophilic head groups with hydroxyl and ester groups, and combinations thereof. It has been discovered that some nonionic surfactants plasticize cellulose esters, alone or in combination with small molecule plasticizers. This is unexpected because traditional plasticizers are small molecules. By contrast, nonionic surfactants are bulky with long hydrocarbon tail groups and potentially large head groups. For example, polyoxyethylene (20) sorbitan monolaurate, which is significantly larger than traditional starch derivative and cellulose derivative plasticizers like triacetin, has been observed to plasticize cellulose ester.

In some embodiments, the plasticizers suitable for use in conjunction with adhesives described herein may be food-grade plasticizers, which may be useful in producing adhesives described herein for use in applications where the adhesive may directly or indirectly contact food (e.g., food containers). Examples of food-grade plasticizers may, in some embodiments, include, but are not limited to, triacetin, diacetin, tripropionin, trimethyl citrate, triethyl citrate, tributyl citrate, eugenol, cinnamyl alcohol, alkyl lactones (e.g., γ-valerolactone), methoxy hydroxy acetophenone (acetovanillone), vanillin, ethylvanillin, polyethylene glycols, 2-phenoxyethanol, glycol ethers, ethylene glycol ethers, propylene glycol ethers, polysorbate surfactants, sorbitan ester surfactants, polyethoxylated aromatic hydrocarbons, polyethoxylated fatty acids, polyethoxylated fatty alcohols, and the like, and any combination thereof.

In some embodiments, the plasticizers suitable for use in conjunction with adhesives described herein may be bio-derived, which may be useful in producing adhesive compositions that are bio-derived. For example, bio-derived triacetin, diacetin, tripropionin, glyceryl esters, may be produced from glycerol that is a byproduct of biodiesel. Other examples of plasticizers that may be bio-derived may include, but are not limited to, vanillin, acetovanillone, γ-valerolactone, eugenol, epoxidized soybean oil, castor oil, linseed oil, epoxidized linseed oil, and dicarboxylic esters (e.g., dimethyl adipate, dibutyl maleate). In some instances, aroma plasticizers may be extracts from natural products, and therefore, bio-derived plasticizers.

In some embodiments, the plasticizers suitable for use in conjunction with adhesives described herein may be semi-volatile to volatile plasticizers. Examples of some preferred semi-volatile to volatile plasticizers may include, but are not limited to, glycerol esters, (e.g., triacetin, diacetin, monoacetin), ethylene glycol diacetate, alkyl lactones (e.g., γ-valerolactone), dibutyl maleate, di-octyl maleate, dibutyl tartrate, eugenol, tributyl phosphate, tributyl-o-acetyl citrate, and resorcinol monoacetate.

In some instances, two or more plasticizers may be used in adhesives. In some instances, it has been surprisingly observed that two or more plasticizers may have synergistic effects. For the same total weight percent of total plasticizer in the adhesive, an adhesive with multiple plasticizers may have a greater melt flow index than an adhesive with the individual plasticizers alone, which is an unexpected observation.

As used herein, the term “starch” refers to a natural polysaccharide that includes amylose and amylopectin in various ratios and derivatives thereof. Example of starches may include, but are not limited to, waxy starches, modified starches, native starches, dextrins, and maltodextrins with dextrose equivalents of 1-50. In some embodiments, the starch and starch derivatives described herein may have an amylose content of about 30% or less, 25% or less, or 10% or less. In some instances, the starch and starch derivatives described herein may have an amylose content of about 1% or less.

In some embodiments, the starch derivatives may be present in the adhesive compositions described herein in an amount ranging from a lower limit of about 0.01%, 1%_{,} 5%, 10%, 25%, or 50% by weight of the adhesive composition to an upper limit of about 95%, 90%, 75%, 65%, 50%, 25%, or 10% by weight of the adhesive composition, wherein the amount may range from any lower limit to any upper limit and encompass any subset therebetween.

The adhesive compositions described herein include starch derivatives. Starch derivatives suitable for use in conjunction with the adhesive compositions described herein may be derived from any suitable starch source. Native, modified, waxy, modified waxy, and hydrolyzed starches can be used. Suitable starch sources may, in some embodiments, include, but are not limited to, cereals, rice, wheat, maize, root vegetables, potatoes, corn, tapioca, cassava, acorns, arrowroot, arracacha, bananas, barley, breadfruit, buckwheat, canna, colacasia, katakuri, kudzu, malanga, millet, oats, oca, polynesian arrowroot, sago, sorghum, sweet potatoes, rye, taro, chestnuts, water chestnuts, yams, beans, favas, lentils, mung beans, peas, chickpeas, and the like, and any combination thereof.

Starch derivatives may, in some embodiments, have ester substituents that include, but are not limited to, C₁-C₂₀ aliphatic esters (e.g., acetate, propionate, or butyrate), functional C₁-C₂₀ aliphatic esters (e.g., acrylates or diesters), aromatic esters (e.g., benzoate or phthalate), substituted aromatic esters, and the like, any derivative thereof, and any combination thereof. Starch derivatives may, in some embodiments, have ether substituents that include, but are not limited to, methylether, ethylether, propylether, hydroxypropylether, hydroxyethylether, hydroxyethyl methylether, hydroxypropyl methylether, carboxymethylether, and the like, and any combination thereof. In some instances, the starch derivatives described herein may have one or more ester substituents and one or more ether substituents.

In some embodiments, the starch derivatives may be bio-derived where not only the starch source is from a biological source, but also the acid or other reactants used to derivatize the starch. For example, acetic anhydride can be produced from a bio-derived acetic acid.

Starch derivatives suitable for use in conjunction with the adhesive compositions described herein may, in some embodiments, have a degree of substitution of the substituent ranging from a lower limit of about 0.5, 1.2, or 2 to an upper limit of about 3, 2.9, 2.7, or 2.5, and wherein the degree of substitution may range from any lower limit to any upper limit and encompass any subset therebetween.

Starch derivatives suitable for use in conjunction with the adhesive compositions described herein may, in some embodiments, have a molecular weight ranging from a lower limit of about 1,000, 15,000, or 25,000 to an upper limit of about 80,000, 50,000, or 30,000, and wherein the molecular weight may range from any lower limit to any upper limit and encompass any subset therebetween. As used herein, the term “molecular weight” refers to a polystyrene equivalent number average molecular weight (“Mₙ”).

In some embodiments, the adhesive compositions described herein may further comprise cellulose derivatives. The inclusion of cellulose derivatives may increase the stiffness and clarity of the adhesive composition. Therefore, higher concentrations of plasticizer may be needed to achieve a more flowable adhesive composition like pressure sensitive adhesives in paste or putty form.

Cellulose derivatives suitable for use in conjunction with the adhesive compositions described herein may, in some embodiments, have ester substituents that include, but are not limited to, C₁-C₂₀ aliphatic esters (e.g., acetate, propionate, or butyrate), functional C₁-C₂₀ aliphatic esters (e.g., acrylates or diesters) aromatic esters (e.g., benzoate or phthalate), substituted aromatic esters, and the like, any derivative thereof, and any combination thereof. Cellulose derivatives suitable for use in conjunction with the adhesive compositions described herein may, in some embodiments, have ether substituents that include, but are not limited to, methylether, ethylether, propylether, hydroxypropylether, hydroxyethylether, hydroxyethyl methylether, hydroxypropyl methylether, carboxymethylether, and the like, and any combination thereof. In some instances, the cellulose derivatives described herein may have one or more ester substituents and one or more ether substituents.

In some embodiments, the cellulose derivatives may be bio-derived where not only the cellulose source is from a biological source, but also the acid or other reactants used to derivatize the cellulose. For example, acetic anhydride can be produced from a bio-derived acetic acid.

Cellulose derivatives suitable for use in conjunction with the adhesive compositions described herein may, in some embodiments, have a degree of substitution of the substituent ranging from a lower limit of about 0.5, 1.2, or 2 to an upper limit of about 3, 2.9, 2.7, or 2.5, and wherein the degree of substitution may range from any lower limit to any upper limit and encompass any subset therebetween.

Cellulose derivatives suitable for use in conjunction with the adhesive compositions described herein may, in some embodiments, have a molecular weight ranging from a lower limit of about 10,000, 15,000, 25,000, 50,000, or 85,000 to an upper limit of about 300,000, 200,000, 150,000, 125,000, 100,000, or 85,000, and wherein the molecular weight may range from any lower limit to any upper limit and encompass any subset therebetween.

In some embodiments, cellulose derivatives described herein may have an intrinsic viscosity ranging from a lower limit of about 0.5 dL/g, 0.7 dL/g, or 1.0 dL/g to an upper limit of about 2.0 dL/g, 1.7 dL/g, 1.5 dL/g, or 1.3 dL/g, and wherein the intrinsic viscosity may range from any lower limit to any upper limit and encompass any subset therebetween. Intrinsic viscosity may be measured by forming a solution of 0.20 g/dL cellulose ester in 98/2 wt/wt acetone/water and measuring the flow times of the solution and the solvent at 30° C. in a #25 Cannon-Ubbelohde viscometer. Then, the modified Baker-Philippoff equation may be used to determine intrinsic viscosity (“IV”), which for this solvent system is Equation 1.

$$IV = ( \frac{k}{c} ) ( antilog ( ( log {n}_{rel} ) / k ) - 1 ) \\ where {n}_{rel} = ( \frac{{t}_{1}}{{t}_{2}} ) , \qquad Equation 1$$

t₁=the average flow time of solution (having cellulose ester) in seconds, t₂=the average flow times of solvent in seconds, k=solvent constant (10 for 98/2 wt/wt acetone/water), and c=concentration (0.200 g/dL).

Cellulose derivatives suitable for use in conjunction with the adhesive compositions described herein may be derived from any suitable cellulosic source. Suitable cellulosic sources may, in some embodiments, include, but are not limited to, softwoods, hardwoods, cotton linters, switchgrass, bamboo, bagasse, industrial hemp, willow, poplar, perennial grasses (e.g., grasses of the Miscanthus family), bacterial cellulose, seed hulls (e.g., soy beans), kudzu, and the like, and any combination thereof. Further, it has been surprisingly discovered that the clarity of adhesives described herein does not appear to be substantially impacted by the cellulosic source from which the cellulose derivatives are derived. This is unexpected because some existing cellulose ester products (that do not have adhesive properties) require high quality, expensive cellulosic sources (e.g., hardwoods with low hemicellulose content) to achieve high clarity.

In some embodiments, the cellulose ester may be recycled from other cellulose ester materials. For example, cellulose acetate tow used in producing, for example, cigarette filters may be used for producing the adhesives described herein.

In some embodiments, the cellulose derivatives may be present in the adhesive compositions described herein in an amount ranging from a lower limit of about 0.01%, 1%, 5%, 10%, 25%, or 50% by weight of the adhesive composition to an upper limit of about 65%, 50%, 25%, or 10% by weight of the adhesive composition, wherein the amount may range from any lower limit to any upper limit and encompass any subset therebetween.

In some embodiments, the adhesive compositions described herein may be substantially water-free. As used herein, the term “water-free” refers to a composition having no more water than is naturally present at standard temperature and pressure with 100% relative humidity. As used herein, the term “substantially water-free” refers to a composition having no more than about 1% by weight of water above the concentration of water that is naturally present at standard temperature and pressure with 100% relative humidity.

In some embodiments, an adhesive composition described herein may comprise starch derivatives, plasticizers, optionally cellulose derivatives, and optionally another polymer. Exemplary other polymers may include, but are not limited to, a polyolefin (e.g., polyethylene and polypropylene), ethylene copolymers (e.g., polymers that comprise ethylene monomers and at least one monomer of vinyl acetate, methyl acrylate, ethyl acrylate, n-butyl acrylate, ethyl methacrylate, acrylic acid, methacrylic acid, propylene, 1-butene, 1-pentene, 1-hexene, 1-heptene, 1-octene, 4-methyl-1-pentene, any derivative thereof, and any combination thereof), a thermoplastic polyurethane, an acrylic acid polymer, polytetrafluoroethylene (“PTFE”), an ethylene vinyl acetate copolymer derivative, a polyester, a polysiloxane, polybutadiene, polyisoprene, poly(methacrylate), poly(methyl methacrylate), a styrene-butadiene-styrene block copolymer, poly(hydroxyethylmethacrylate) (“pHEMA”), poly(vinyl chloride), poly(vinyl acetate), a polyether, a polyacrylonitrile, a polyethylene glycol, polymethylpentene, polybutadiene, polyhydroxy alkanoates, poly(lactic acid), poly(glycolic acid), acrylic acid-based polymers, a methacrylic acid based polymer, a polyanhydride, a polyorthoester, cross-linked poly(vinyl alcohol), neoprene rubber, butyl rubber, polyvinyl acetate phthalate, polyvinyl acetate, shellac, zein, polyethylene oxide (“PEO”), ethylene oxide-propylene oxide copolymers (include block copolymers like PLURONICS® (polyethylene oxide-polypropylene oxide-polyethylene oxide triblock polymers, available from BASF)), polyethylene-polypropylene glycol (e.g., poloxamer), carbomer, polycarbophil, chitosan, polyvinyl pyrrolidone (“PVP”), poly(vinyl alcohol) (“PVOH”), a polyethyleneimine, a polyacrylate, a polyacrylamide, a polymethacrylamide, a polyphosphazine, a polyoxazolidine, a polyhydroxyalkylcarboxylic acid, an alginic acid (e.g., carrageenate alginates, ammonium alginate, and sodium alginate), natural gums (e.g., gum guar, gum acacia, gum tragacanth, karaya gum, and gum xanthan), povidone, gelatin, and the like, any derivative thereof, any copolymer thereof, any blend polymer thereof, and combinations thereof.

In some instances, the additional polymers blended with the starch derivatives may be sufficiently hydrophobic that a compatibilizer is needed to produce a homogeneous blend. Exemplary compatibilizers for use in conjunction with such blends may be nonionic surfactants that include, but are not limited to, polysorbates (e.g., TWEEN®20 or TWEEN®80, available from SigmaAldrich), sorbitan esters (e.g., SPAN® products available from SigmaAldrich), polyethoxylated aromatic hydrocarbons (e.g., TRITON® products available from SigmaAldrich), polyethoxylated fatty acids, polyethoxylated fatty alcohols (e.g., BRIJ® products available from SigmaAldrich), fluorosurfactants, glucosides, and other nonionic surfactants with hydrocarbon tails (e.g., C₆-C₂₂ alkyl groups) and hydrophilic head groups with hydroxyl and ester groups, and combinations thereof. Additional exemplary compatibilizers for use in conjunction with the blends may be polymers that include, but are not limited to, polyethylene glycol less than about 2000 molecular weight. Combinations of the foregoing may also be used. In some embodiments, compatibilizers may be present in the base polymer composition in an amount of about 0.5% to about 20% by weight of the adhesive composition.

Tackifiers may, in some embodiments, increase the adhesion properties of the adhesive compositions described herein. In some embodiments, a tackifying resin may be present in an adhesive described herein in an amount ranging from a lower limit of 0%, about 1%, 5%, 10%, 20%, or 30% by weight of the adhesive described herein to an upper limit of about 70%, 60%, 50%, 40%, or 30% by weight of the adhesive described herein, and wherein the amount of tackifying resin may range from any lower limit to any upper limit and encompass any subset therebetween.

Tackifiers suitable for use in conjunction with the adhesive compositions described herein may, in some embodiments, include, but are not limited to, methylcellulose, ethylcellulose, hydroxyethylcellulose, carboxy methylcellulose, carboxy ethylcellulose, amides, diamines, polyesters, polycarbonates, silyl-modified polyamide compounds, polycarbamates, urethanes, natural resins, natural rosins, rosin esters (SYLVATAC® RE85 and SYLVALITE® RE100, both esters of tall oil rosin, available from Arizona Chemical), shellacs, acrylic acid polymers, 2-ethylhexylacrylate, acrylic acid ester polymers, acrylic acid derivative polymers, acrylic acid homopolymers, anacrylic acid ester homopolymers, poly(methyl acrylate), poly(butyl acrylate), poly(2-ethylhexyl acrylate), acrylic acid ester co-polymers, methacrylic acid derivative polymers, methacrylic acid homopolymers, methacrylic acid ester homopolymers, poly(methyl methacrylate), poly(butyl methacrylate), poly(2-ethylhexyl methacrylate), acrylamido-methyl-propane sulfonate polymers, acrylamido-methyl-propane sulfonate derivative polymers, acrylamido-methyl-propane sulfonate co-polymers, acrylic acid/acrylamido-methyl-propane sulfonate co-polymers, benzyl coco di-(hydroxyethyl) quaternary amines, p-T-amyl-phenols condensed with formaldehyde, dialkyl amino alkyl(meth)acrylates, acrylamides, N-(dialkyl amino alkyl) acrylamide, methacrylamides, hydroxy alkyl(meth)acrylates, methacrylic acids, acrylic acids, hydroxyethyl acrylates, ethylene vinyl acetate, vinyl acetate ethylene polymers, aliphatic hydrocarbons, cycloaliphatic hydrocarbons (e.g., EASTOTAC® products, available from Eastman Chemical Co.), aromatic hydrocarbons, aromatically modified aliphatic hydrocarbons, cycloaliphatic hydrocarbons, hydrogenated versions of the foregoing hydrocarbons, terpenes, polyterpenes, modified terpenes (e.g., phenolic modified terpene resins like SYLVARES™ TP96 and SYLVARES™ TP2040, available from Arizona Chemical), and the like, any derivative thereof, and any combination thereof.

In some embodiments, tackifiers suitable for use in conjunction with the adhesive compositions described herein may be food-grade tackifiers. Examples of food-grade tackifiers may, in some embodiments, include, but are not limited to, methylcellulose, ethylcellulose, hydroxyethylcellulose, carboxy methylcellulose, carboxy ethylcellulose, natural resins, natural rosins, and the like, and any combination thereof.

In some embodiments, compatibilizers may be used to more homogeneously incorporate tackifying resins into an adhesive described herein. Suitable compatibilizers may include those described above relative to the additional polymers and may be used at similar concentrations.

In some embodiments, the starch derivative, plasticizer, and optionally cellulose derivative may provide sufficient tack such that little to no additional tackifying resins (e.g., about 5% or less weight of adhesive described herein) are required in an adhesive described herein.

In some embodiments, a wax may be present in an adhesive described herein in an amount ranging from a lower limit of 0%, about 1%, 5%, 10%, or 20% by weight of adhesive described herein to an upper limit of about 40%, 30%, or 20% by weight of adhesive described herein, and wherein the amount of wax may range from any lower limit to any upper limit and encompass any subset therebetween.

In some embodiments, waxes may have a melting temperature of about 45° C. to about 125° C.

Examples of waxes suitable for use in conjunction with the adhesives described herein may, in some embodiments, include, but are not limited to, paraffin waxes (e.g., PACEMAKER® products, available from Citgo Petroleum, OKERIN® products, available from Astor Wax Corporation, PENRECO® products, available from Pennzoil Products Co, R-7152 products, available from Moore & Munger, and PARAFIN WAX 1297, available from International Waxes Ltd.), microcrystalline waxes (e.g., VICTORY® AMBER WAX, available from Petrolite Corp, BARECO® ES-796 Amber Wax, available from Bareco, and OKERIN® 177, available from Astro Wax Corporation), polyethylene waxes (e.g., POLYWAX® products, available from Petrolite, Inc.), polypropylene waxes, by-product polyethylene waxes, Fischer-Tropsch waxes, and the like, and combinations thereof.

In some embodiments, the adhesive compositions described herein may further comprise additives. Additives suitable for use in conjunction with the adhesive compositions described herein may include, but are not limited to, tackifiers, crosslinkers, insolubilizers, fillers, thickeners, rigid compounds, water-resistance additives, flame retardants, lubricants, softening agents, antibacterial agents, antifungal agents, pigments, dyes, antioxidants, UV-stabilizers, resins, rosins, waxes, flowing agents, viscosity modifiers, aromas, and the like, and any combination thereof.

In some embodiments, compatibilizers may be used to more homogeneously incorporate waxes into an adhesive described herein. Suitable compatibilizers may include those described above relative to the base polymer composition and may be used at similar concentrations.

In some embodiments, the additives may be present in the adhesive compositions described herein in an amount ranging from a lower limit of about 0.1%, 1%, 5%, or 10% by weight of the adhesive composition to an upper limit of about 75%, 60%, 50%, 25%, 20%, 15%, or 10% by weight of the adhesive composition, wherein the amount may range from any lower limit to any upper limit and encompass any subset therebetween.

Crosslinkers may, in some embodiments, increase the adhesive properties and/or increase water-resistance of the adhesive compositions described herein. Crosslinkers suitable for use in conjunction with the adhesive compositions described herein may, in some embodiments, include, but are not limited to, zirconium salts, boric acid, borate salts, ammonium zirconium carbonate, potassium zirconium carbonate, metal chelates (e.g., zirconium chelates, titanium chelates, or aluminum chelates), formaldehyde crosslinkers, polyamide epichlorohydrin resin, crosslinkers containing N-methylol groups and/or etherified N-methylol groups (e.g., ARKOFIX® (an ultra-low formaldehyde crosslinking agent, available from Clariant)), glyoxal, urea glyoxal adduct crosslinkers, urea formaldehyde adduct crosslinkers, melamine formaldehyde, 4,5-dihydroxy-N,N′-dimethylolethyleneurea, hydroxymethylated cyclic ethyleneureas, hydroxymethylated cyclic propyleneureas, hydroxymethylated bicyclic glyoxal diurea, hydroxymethylated bicyclic malonaldehyde diureas, dialdehydes, protected dialdehydes, bisulfite protected aldehydes, isocyanates, blocked isocyanates, dimethyoxytetrahydrafuran, dicarboxylic acids, epoxides, diglycidyl ether, hydroxymethyl-substituted imidazolidinone, 1,3-dimethylol-4,5-dihydroxyimidazolidinone, hydroxymethyl-substituted pyrimidinones, hydroxymethyl-substituted triazinones, epoxides, epoxidized natural oils (e.g., epoxidized soy oil or expoxidized linseed oil), oxidized starch, oxidized polysaccharides, oxidized hemicellulose, and the like, any derivative thereof, and any combination thereof. One skilled in the art with the benefit of this disclosure should understand that formaldehyde crosslinkers should be excluded from use in conjunction with formaldehyde-free adhesive compositions, and limited in substantially formaldehyde-free adhesive compositions (i.e., the adhesive comprising less than 0.01% formaldehyde by weight of the adhesive). In some embodiments, crosslinkers suitable for use in conjunction with the adhesive compositions described herein may be food-grade crosslinkers.

Water-resistance additives may, in some embodiments, increase the water-resistance properties of the adhesive compositions described herein, which may consequently yield articles capable of maintaining their mechanical properties in environments with higher water concentrations, e.g., humid environments. Water-resistance additives suitable for use in conjunction with the adhesive compositions described herein may, in some embodiments, include, but are not limited to, waxes, polyolefins, insolublizers, ethylene vinyl acetate, vinyl acetate ethylene polymers, octenyl succinyls, alkenyl succinyls, and the like, and any combination thereof.

In some embodiments, water-resistance additives suitable for use in conjunction with the adhesive compositions described herein may be food-grade water-resistance additives. Examples of food-grade water-resistance additives may, in some embodiments, include, but are not limited to, waxes, polyolefins, ethylene vinyl acetate, vinyl acetate ethylene polymers, and the like, and any combination thereof.

Fillers may, in some embodiments, increase the rigidity and decrease the creep of the adhesive compositions described herein, which may consequently increase the mechanical rigidity of an article produced therewith. Surprisingly, it has been observed that the inclusion of fillers has improved the adhesive strength of the adhesive compositions described herein. Typically, fillers in adhesives reduce the efficacy of the adhesive, which makes the increased strength observed for the present adhesive compositions unexpected.

Fillers suitable for use in conjunction with the adhesive compositions described herein may, in some embodiments, include, but are not limited to, coconut shell flour, walnut shell flour, wood flour, wheat flour, soybean flour, gums, protein materials, calcium carbonate, talc, zeolite, clay, rigid compounds (e.g. lignin), thickeners, unreacted starches, modified starches (e.g., with modifications other than ester modifications like hydroxyethyl starch, hydrolyzed starch, cationic starch, starch phosphate, oxidized starch, and the like), waxy starches, cellulose nanofibrils, nanocrystalline cellulose, glass microspheres, and the like, and any combination thereof.

In some embodiments, fillers suitable for use in conjunction with the adhesive compositions described herein may be food-grade fillers. Examples of food-grade fillers may, in some embodiments, include, but are not limited to, coconut shell flour, walnut shell flour, wood flour, wheat flour, soybean flour, gums, starches, protein materials, calcium carbonate, and the like, and any combination thereof.

Flame retardants suitable for use in conjunction with the adhesive compositions described herein may, in some embodiments, include, but are not limited to, silica, metal oxides, phosphates, catechol phosphates, resorcinol phosphates, borates, inorganic hydrates, aromatic polyhalides, and the like, and any combination thereof.

Antifungal and/or antibacterial agents suitable for use in conjunction with the adhesive compositions described herein may, in some embodiments, include, but are not limited to, polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

Pigments and dyes suitable for use in conjunction with the adhesive compositions described herein may, in some embodiments, include, but are not limited to, plant dyes, vegetable dyes, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L), and the like, any derivative thereof, and any combination thereof.

In some embodiments, pigments and dyes suitable for use in conjunction with the adhesive compositions described herein may be food-grade pigments and dyes. Examples of food-grade pigments and dyes may, in some embodiments, include, but are not limited to, plant dyes, vegetable dyes, titanium dioxide, and the like, and any combination thereof.

Antioxidants may, in some embodiments, mitigate oxidation and/or chemical degradation of the adhesive compositions described herein during storage, transportation, and/or implementation. Antioxidants suitable for use in conjunction with the adhesive compositions described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, and delta-tocopherol), tocotrienols, tocopherol esters (e.g., tocopherol acetate), ubiquinol, gallic acids, melatonin, secondary aromatic amines, benzofuranones, hindered phenols, polyphenols, hindered amines, organophosphorus compounds, thioesters, benzoates, lactones, hydroxylamines, butylated hydroxytoluene (“BHT”), butylated hydroxyanisole (“BHA”), hydroquinone, and the like, and any combination thereof.

In some embodiments, antioxidants suitable for use in conjunction with the adhesive compositions described herein may be food-grade antioxidants. Examples of food-grade antioxidants may, in some embodiments, include, but are not limited to, ascorbic acid, vitamin A, tocopherols, tocopherol esters, beta-carotene, flavonoids, BHT, BHA, hydroquinone, and the like, and any combination thereof.

Viscosity modifiers may, in some embodiments, be advantageous in modifying the melt flow index of the adhesive compositions described herein and/or modify the viscosity of adhesive compositions described herein that are in a paste or putty form. Viscosity modifiers suitable for use in conjunction with adhesive compositions described herein may, in some embodiments, include, but are not limited to, polyethylene glycols, polypropylene glycols, and the like, and any combination thereof, which, in some embodiments, may be a food-grade viscosity modifier.

Aromas suitable for use in conjunction with the adhesive compositions described herein may, in some embodiments, include, but are not limited to, spices, spice extracts, herb extracts, essential oils, smelling salts, volatile organic compounds, volatile small molecules, methyl formate, methyl acetate, methyl butyrate, ethyl acetate, ethyl butyrate, isoamyl acetate, pentyl butyrate, pentyl pentanoate, octyl acetate, myrcene, geraniol, nerol, citral, citronellal, citronellol, linalool, nerolidol, limonene, camphor, terpineol, alpha-ionone, thujone, benzaldehyde, eugenol, isoeugenol, cinnamaldehyde, ethyl maltol, vanilla, vanillin, cinnamyl alcohol, anisole, anethole, estragole, thymol, furaneol, methanol, rosemary, lavender, citrus, freesia, apricot blossoms, greens, peach, jasmine, rosewood, pine, thyme, oakmoss, musk, vetiver, myrrh, blackcurrant, bergamot, grapefruit, acacia, passiflora, sandalwood, tonka bean, mandarin, neroli, violet leaves, gardenia, red fruits, ylang-ylang, acacia farnesiana, mimosa, tonka bean, woods, ambergris, daffodil, hyacinth, narcissus, black currant bud, iris, raspberry, lily of the valley, sandalwood, vetiver, cedarwood, neroli, strawberry, carnation, oregano, honey, civet, heliotrope, caramel, coumarin, patchouli, dewberry, helonial, coriander, pimento berry, labdanum, cassie, aldehydes, orchid, amber, benzoin, orris, tuberose, palmarosa, cinnamon, nutmeg, moss, styrax, pineapple, foxglove, tulip, wisteria, clematis, ambergris, gums, resins, civet, plum, castoreum, civet, myrrh, geranium, rose violet, jonquil, spicy carnation, galbanum, petitgrain, iris, honeysuckle, pepper, raspberry, mango, coconut, hesperides, castoreum, osmanthus, mousse de chene, nectarine, mint, anise, cinnamon, orris, apricot, plumeria, marigold, rose otto, narcissus, tolu balsam, frankincense, amber, orange blossom, bourbon vetiver, opopanax, white musk, papaya, sugar candy, jackfruit, honeydew, lotus blossom, muguet, mulberry, absinthe, ginger, juniper berries, spicebush, peony, violet, lemon, lime, hibiscus, white rum, basil, lavender, balsamics, fo-ti-tieng, osmanthus, karo karunde, white orchid, calla lilies, white rose, rhubrum lily, tagetes, ambergris, ivy, grass, seringa, spearmint, clary sage, cottonwood, grapes, brimbelle, lotus, cyclamen, orchid, glycine, tiare flower, ginger lily, green osmanthus, passion flower, blue rose, bay rum, cassie, African tagetes, Anatolian rose, Auvergne narcissus, British broom, British broom chocolate, Bulgarian rose, Chinese patchouli, Chinese gardenia, Calabrian mandarin, Comoros Island tuberose, Ceylonese cardamom, Caribbean passion fruit, Damascena rose, Georgia peach, white Madonna lily, Egyptian jasmine, Egyptian marigold, Ethiopian civet, Farnesian cassie, Florentine iris, French jasmine, French jonquil, French hyacinth, Guinea oranges, Guyana wacapua, Grasse petitgrain, Grasse rose, Grasse tuberose, Haitian vetiver, Hawaiian pineapple, Israeli basil, Indian sandalwood, Indian Ocean vanilla, Italian bergamot, Italian iris, Jamaican pepper, May rose, Madagascar ylang-ylang, Madagascar vanilla, Moroccan jasmine, Moroccan rose, Moroccan oakmoss, Moroccan orange blossom, Mysore sandalwood, Oriental rose, Russian leather, Russian coriander, Sicilian mandarin, South African marigold, South American tonka bean, Singapore patchouli, Spanish orange blossom, Sicilian lime, Reunion Island vetiver, Turkish rose, Thai benzoin, Tunisian orange blossom, Yugoslavian oakmoss, Virginian cedarwood, Utah yarrow, West Indian rosewood, and the like, and any combination thereof.

In some instances, a component of an adhesive described herein may perform more than one function in the adhesive described herein. For example, BHT and BHA are both antioxidants and plasticizers for starch derivatives. Additionally, nonionic surfactants may, in some instances, function as both plasticizers and compatibilizers. In another example, aromas like eugenol, cinnamyl alcohol, camphor, methoxy hydroxy acetophenone (acetovanillone), vanillin, and ethylvanillin may also plasticize starch derivatives. In yet another example, benzoates and parabens (e.g., the propyl-4-hydroxybeonzoate series) may be both preservatives and plasticizers for starch derivatives.

In some embodiments, the adhesive compositions described herein may be food-grade adhesive compositions that comprise food-grade starch derivatives, food-grade plasticizers, optionally food-grade cellulose derivatives, and optionally food-grade additives.

In some embodiments, the adhesive compositions described herein may be at least in part bio-derived adhesive compositions. In some embodiments, the amount of the adhesive composition that is bio-derived may range from a lower limit of about 2%, 5%, 10%, 25%, 50%, 75%, or 90% to an upper limit of about 100%, 99%, 95%, 90%, 75%, or 50%, and wherein the amount of the adhesive composition that is bio-derived may range from any lower limit to any upper limit and encompasses any subset therebetween.

### II. Properties of the Adhesive Compositions

The physical and chemical properties of each of the components of the adhesive compositions described herein may be tailored to achieve the desired characteristics of the adhesive compositions. Examples of such properties may include, but are not limited to, the composition of the ester substituents of the starch derivatives, the degree of substitution of the ester substituent of the starch derivatives, the molecular weight of the starch derivatives, the composition of the plasticizers, the composition of the ester substituents of the cellulose derivatives, the degree of substitution of the ester substituent of the cellulose derivatives, the molecular weight of the cellulose derivatives, the composition of the additives, and the like, and any combination thereof. Further, the amount of each component in the adhesive compositions described herein may be tailored to achieve the desired characteristics of the adhesive compositions.

The characteristics of the adhesive compositions described herein that can be tailored may include, but are not limited to, glass transition temperature, melt flow index, adhesive strength, degradability, clarity, and the like, and any combination thereof.

Tailoring the glass transition temperature of the adhesive compositions described herein may alter the physical characteristics of the adhesive composition at ambient conditions (e.g., stiff or flexible, brittle or pliable, smooth or tacky, and the like, and any combination thereof). For example, adhesive compositions having no detectable glass transition temperature may be more tacky and flexible than those having a glass transition temperature. As used herein, the term “no detectable glass transition temperature” and derivatives thereof refers to material having no detectible heat flow event (as measured by differential scanning calorimeter (“DSC”)), which may be caused by the plasticized material having no glass transition temperature or the heat flow broadening to an extent that the glass transition temperature is not detectable.

In another example, adhesive compositions having higher glass transition temperatures may be more stiff and/or brittle than those having moderate to low glass transition temperatures. In some embodiments, tailoring the glass transition temperature of the adhesive compositions described herein may be achieved by, inter alia, changing the plasticizer concentration (e.g., increasing the concentration to decrease the glass transition temperature), changing the composition and or concentration of the plasticizer, the starch source, the composition and/or concentration of additives, the molecular weight, and the degree of substitution of the starch derivative and/or cellulose derivative (e.g., in some instances, increasing the degree of substitution to increase the glass transition temperature).

In some embodiments, the adhesive compositions described herein (including any type of adhesive composition described herein) may have a glass transition temperature of about 190° C. or less. In some instances, the adhesive compositions described herein may have a glass transition temperature ranging from a lower limit of about −100° C., −75° C., −70° C., −30° C., 10° C., 75° C., or 120° C. to an upper limit of about 190° C., 150° C., 125° C., or 100° C., and wherein the glass transition temperature may range from any lower limit to any upper limit and encompass any subset therebetween. In some instances, the adhesive compositions described herein (including any type of adhesive composition described herein) may have no detectible glass transition temperature above about −100° C.

The glass transition temperature of an adhesive composition can be measured by either DSC or rheology. One skilled in the art with the benefit of this disclosure would understand that the glass transition temperature value may fall outside the preferred range described herein, which may depend on, inter alia, the composition and concentration of the plasticizers, the composition of the starch derivatives, the source of starch, the composition of the cellulose derivatives, and molecular weight of the starch derivatives used to produce adhesive samples. Accordingly, within the scope of the embodiments described herein, the glass transition can be manipulated based on the composition and concentration of additives included in the adhesives.

Tailoring the melt flow index of adhesive compositions described herein may allow for the use of the adhesive compositions over a wide variety of applications. For example, lower melt flow index adhesive compositions may be useful in applications where shape is retained until heating (e.g., window films, glue sticks, and pelletized adhesive compositions), while higher melt flow index adhesive compositions may be useful in applications where a pliable or even spreadable adhesive compositions are desired (e.g., for creating thin films for self-adhesive stamps and envelopes). In some embodiments, tailoring the melt flow index of the adhesive compositions described herein may be achieved by, inter alia, changing the plasticizer composition, changing the plasticizer concentration (e.g., increasing the concentration to increase the melt flow index), changing the molecular weight of the starch derivative and/or cellulose derivative (e.g., decreasing molecular weight to increase the melt flow index), changing the starch source, starch modification, and changing the composition and/or concentration of additives.

In some embodiments, the adhesive compositions described herein (including any type of adhesive composition described herein) may have a melt flow index (with a 300 sec melt time) ranging from a lower limit of about 0 g/10 min, 5 g/10 min, 25 g/10 min, 29 g/10 min, 35 g/10 min, or 40 g/10 min (at 125° C./0.5 kg measured in accordance with ASTM D1238) to an upper limit of about 150 g/10 min, 125 g/10 min, 100 g/10 min, 80 g/10 min, 70 g/10 min, 60 g/10 min, 50 g/10 min, or 40 g/10 min (at 125° C./0.5 kg measured in accordance with ASTM D1238), and wherein the melt flow index may range from any lower limit to any upper limit and encompass any subset therebetween. In some instances where the melt flow index at 125° C./500 g is greater than 150 g/10 min, the melt flow index may be measured at 125° C./100 g and range from a lower limit of about 5 g/10 min, 25 g/10 min, 29 g/10 min, 35 g/10 min, or 40 g/10 min (at 125° C./100 g measured in accordance with ASTM D1238) to an upper limit of about 500 g/10 min, 400 g/10 min, 300 g/10 min, 200 g/10 min, 100 g/10 min, 86 g/10 min, 80 g/10 min, 70 g/10 min, 60 g/10 min, 50 g/10 min, or 40 g/10 min (at 125° C./100 g measured in accordance with ASTM D1238), and wherein the melt flow index may range from any lower limit to any upper limit and encompass any subset therebetween.

It should be noted that the melt flow index of the adhesive compositions described herein may fall outside the ranges described herein depending on, inter alia, the additive (e.g., fillers, tackifiers, and the like), included in the adhesive. In some embodiments, the adhesive compositions described herein may have a melt flow index that is higher than can be measured at 125° C./100 g for a given apparatus.

Tailoring the adhesive strength of adhesive compositions described herein may allow for the use of the adhesive compositions over a wide variety of applications. For example, a lower adhesive strength may be useful in semi-permanent adhesive applications between substrates with lower mechanical properties (e.g., sticky-notes), while higher adhesive strength may be useful in permanent to semi-permanent applications between substrates with higher mechanical properties (e.g., adhering the cardboard packaging of mailing boxes or laminating applications). In some instances, the adhesive strength may increase over time allowing for a repositionable article initially that becomes permanent to semi-permanent.

Further, in some instances, higher adhesive strength may be useful in forming a film on a substrate (e.g., laminating paper such that the adhesive composition forms a protective coating/laminate on the paper). In some embodiments, tailoring the adhesive strength of the adhesive compositions described herein may be achieved by, inter alia, changing the plasticizer composition, changing the plasticizer concentration (e.g., increasing the concentration to decrease the adhesive strength), changing the molecular weight of the starch derivative and/or cellulose derivative (e.g., decreasing molecular weight to decrease the adhesive strength), and changing the composition and/or concentration of additives (e.g., increasing crosslinker, tackifier, and/or filler concentration to increase the adhesive strength).

Adhesive strength may be measured by peel adhesion and/or lap shear strength.

In some embodiments, the adhesive compositions described herein (including any type of adhesive composition described herein) may have a peel adhesion (using with a 4 mil coated paper backing) ranging from a lower limit of about 0.1 lb/in, 0.25 lb/in, 0.5 lb/in, 1 lb/in, 2 lb/in, 3 lb/in, 4 lb/in, or 5 lb/in to an 25 lb/in, 20 lb/in, 15 lb/in, or 10 lb/in, and wherein the peel adhesion may range from any lower limit to any upper limit and encompass any subset therebetween. Depending on the substrate, in some instances, the substrate may fail (e.g., tear) before the adhesive composition. The peel adhesion can be measured by ASTM 3330/D Method A (Standard test method for peel adhesion of PSA tape (180° Peel)) and tested on a surface of interest (e.g., corrugated cardboard, glass, stainless steel panels). Test method A gives a measure of the adherence, when peeled at 180° angle, to a standard steel panel or to other surfaces of interest (e.g., corrugated board or glass) for a single-coated tape. This test method provides a mean for assessing the uniformity of the adhesion of a given type of adhesive. In this method, a strip is applied to a standard test panel (or other surface of interest) with controlled pressure. The tape is peeled from the panel at 180° angle at a specified rate with a 1 kN load cell, during which the force required to effect peel is measured. One skilled in the art with the benefit of this disclosure would understand that the peel adhesion described herein may have a range of peel adhesion depending on the adhesive composition, the coat weight of the adhesive, and the substrate to which it is adhered to.

In some embodiments, the adhesive composition described herein may increase in peel adhesion over time when applied to a substrate or surface. A measurement of a change in peel adhesion over time may be analyzed by comparing the 24 hour peel adhesion to the 72 hour peel adhesion. As used herein, the “72-hr percent increase in peel adhesion” is calculated by (peel adhesion at 72 hours−peel adhesion at 24 hours)/(peel adhesion at 24 hours)*100. In some instances, an adhesive composition described herein may have a 72-hr percent increase in peel adhesion ranging from a lower limit of about 3%_{,} 5%, or 10% to an upper limit of about 300%, 150%, 75%, or 25%, and wherein the percent increase in peel adhesion may range from any lower limit to any upper limit and encompass any subset therebetween.

The lap shear strength of an adhesive composition can be measured by testing lap shears by tension loading with a 1 kN load cell by a method that includes placing a specimen (two substrates with a 1 inch by 1 inch overlap and 3 mm thick glue line) in the grips of the testing machine so that each end of the specimen is in contact with the grip assemble, applying the loading immediately to the specimen at the rate of 800 lb force of shear per min, and continuing the load to failure of the adhesive or substrate. Adhesives failure is recorded as the lap shear strength, and substrate failure is recorded as substrate failure. In some instances, substrate failure for a 4 mil coated paper has been observed at about 17 kgf. This value may change depending on the substrate and size of the glue line.

In some embodiments, the adhesive compositions described herein may have a lap shear strength (using with a 4 mil coated paper backing) ranging from a lower limit of about 0.2 kgf, 0.5 kgf, 1 kgf, 2 kgf, 4 kgf, or 6 kgf to an upper limit of about 17 kgf, 15 kgf, 10 kgf, 8 kgf, 6 kgf, or 4 kgf, and wherein the lap shear strength may range from any lower limit to any upper limit and encompass any subset therebetween. In some instances, the 4 mil coated paper may fail before the adhesive composition. In some embodiments, the adhesive compositions described herein may have a lap shear strength (using an aluminum or stainless steel substrate) ranging from a lower limit of about 0.2 kgf, 0.5 kgf, 1 kgf, 2 kgf, 5 kgf, or 10 kgf to an upper limit of about 30 kgf, 25 kgf, 20 kgf, 15 kgf, or 10 kgf, and wherein the lap shear strength may range from any lower limit to any upper limit and encompass any subset therebetween.

One skilled in the art would recognize that the peel adhesion, the peel adhesion over time, and the lap shear strength may be outside the preferred ranges described herein depending on the composition and concentration of plasticizer, the degree of substitution of the starch derivative and the cellulose derivative, the inclusion or exclusion of a cellulose derivative, the composition and concentration of individual additives, and the like.

Tailoring the degradability of adhesive compositions described herein may contribute to the overall degradability of products and articles comprising the adhesive compositions. In some embodiments, tailoring the degradability of the adhesive compositions described herein may be achieved by, inter alia, changing the plasticizer composition (e.g., using a plasticizer that biodegrades or dissipates into the environment at a higher rate to increase the degradability), changing the plasticizer concentration (e.g., increasing the concentration to increase the degradability), changing the degree of substitution of the starch derivative and/or cellulose derivative (e.g., decreasing the degree of substitution to increase the degradability), and changing the composition and/or concentration of additives (e.g., increasing antioxidant and/or stabilizer concentration to decrease the degradability).

In some embodiments, the adhesive compositions described herein (e.g., hot melt adhesives, pressure sensitive hot melt adhesives, and pressure sensitive adhesives) may degrade to a greater extent for a given time frame than a cellulose diacetate material plasticized with 20% triacetin. In some embodiments, the adhesive compositions may degrade by about 5% or greater by weight than a cellulose diacetate material plasticized with 20% triacetin in a procedure performed according to EN13432 “Requirements for Packaging Recoverable through Composting and Biodegradation—Test Scheme and Evaluation Criteria for the Final Acceptance of Packaging.” In some embodiments, the adhesive compositions described herein (e.g., hot melt adhesives, pressure sensitive hot melt adhesives, and pressure sensitive adhesives) may degrade by an amount ranging from a lower limit of about 5%, 10%, or 15% to an upper limit of about 2000%, 1000%, 500%, 300%, 200%, 100%, 50%, 40%, or 30% by weight than a cellulose diacetate material plasticized with 20% triacetin in a procedure performed according to EN13432 “Requirements for Packaging Recoverable through Composting and Biodegradation—Test Scheme and Evaluation Criteria for the Final Acceptance of Packaging,” and wherein the degradation may range from any lower limit to any upper limit and encompass any subset therebetween. In some instances, the comparative rate of degradation may be outside the range described herein depending on the concentration of the plasticizer, the composition of the plasticizer, and the composition of the cellulose derivative.

The clarity of the adhesive compositions described herein may be important in some applications, e.g., high clarity (or low haze) may be necessary when the adhesive compositions are used in conjunction with high clarity (or low haze) films (e.g., window tints or CLARIFOIL® packaging) or high clarity laminate films (e.g., laminate or protective coatings on substrates like paper). In some embodiments, tailoring the clarity of the adhesive compositions described herein may be achieved by, inter alia, changing the source of starch, changing the plasticizer composition and/or concentration (e.g., increasing the concentration to increase the clarity/decrease the haze) and changing the composition and/or concentration of additives (e.g., increasing the filler concentration to decrease the clarity/increase the haze).

In some embodiments, the adhesive compositions described herein (e.g., hot melt adhesives, pressure sensitive hot melt adhesives, and pressure sensitive adhesives) may have a haze ranging from a lower limit of about 3, 5, 15, 20, or 25 to an upper limit of about 100 (i.e., intentionally opaque), 85, 70, 60, or 40, and wherein the haze may range from any lower limit to any upper limit and encompass any subset therebetween. The haze of an adhesive composition can be measured with properly sized specimens substantially plane-parallel surfaces (e.g., flat without wrinkling) free of dust, scratches, and particles of about 0.85 mm in thickness using an UtraScan Pro from Hunter Lab with D65 Illuminant/10° observer. One skilled in the art with the benefit of this disclosure would understand that the haze value may fall outside the preferred ranges described herein for different thickness of an adhesive sample. In some instances, the haze value may be significantly larger than the preferred ranges above (e.g., about 100) when additives like titanium dioxide are used in significant quantities to produce an opaque adhesive. Additionally, pigments and dyes may affect the haze of the adhesive.

### III. Methods Relating to Adhesive Compositions

Some embodiments of the present invention may involve producing adhesive compositions described herein. Suitable methods may, in some instances, involve compounding starch derivatives described herein and plasticizers described herein (optionally with cellulose derivatives and additives) at a suitable concentration. Suitable methods may, in some instances, involve high-shear mixing of the starch derivatives described herein and plasticizers described herein (optionally with cellulose derivatives and additives) at a suitable concentration. In some instances, compounding or high-shear mixing may optionally be at an elevated temperature (e.g., forming an adhesive melt).

Some embodiments may involve using the adhesive compositions immediately for an application (e.g., applying an adhesive melt to a substrate so as to form a laminate surface on the substrate or using a paste or putty produced from compounding), while other embodiments may involve forming the adhesive compositions into a desired form (e.g., a paste, a putty, pellets, or a molded shape (e.g., a glue stick or an adhesive sheet)). Forming the adhesive compositions into a desired form may, in some embodiments, involve methods like extruding, injection molding, blow molding, over molding, compression molding, casting, calendaring, near net shape molding, and the like, any hybrid thereof, and any combination thereof.

In some embodiments, additives may be incorporated into the adhesive compositions by inclusion in the compounding step. In some embodiments, additives may be incorporated into the adhesive compositions after the compounding step by, for example, absorption. Absorption may, in some embodiments, be advantageous for the incorporation volatile additives and/or small molecule additives (e.g., some fragrances, aromas, dyes, and pigments).

In some embodiments, the adhesive compositions (e.g., a hot melt adhesive) in sheet form may be smooth and substantially non-tacky at room temperature. In some embodiments, such adhesive compositions may be heated to initiate adhesion to a surface(s) (e.g., iron-on designs or laminating sheets disposed between two substrates).

In some embodiments, the adhesive compositions (e.g., a pressure sensitive hot melt adhesive) in sheet form may be non-tacky or tacky at room temperature. In some embodiments, such adhesive compositions may be heated to facilitate adhesion to a surface(s). In some instances, such an adhesive composition may be repositionable initially and increase in strength over time or with the application of heat so as to become semi-permanent to permanent.

In some embodiments, the adhesive compositions (e.g., a pressure sensitive hot melt adhesive or a pressure sensitive adhesive) be disposed on a substrate (e.g., one side of a plastic or nonwoven) may be repositionable initially and increase in strength over time or with the application of heat so as to become semi-permanent to permanent.

In some embodiments, the adhesive compositions in sheet form may have a thickness ranging from a lower limit of about 15 microns, 20 microns, 30 microns, 50 microns, or 100 microns to an upper limit of about 1200 microns, 800 microns, 500 microns, 400 microns, 300 microns, 200 microns, or 100 microns, and wherein the thickness may range from any lower limit to any upper limit and encompasses any subset therebetween. While these thicknesses may be preferred, one skilled in the art, with the benefit of this disclosure, should understand that the thicknesses described and not limiting to the structure of a sheet and thicknesses outside these ranges may be achieved.

In some instances, an adhesive composition described herein (e.g., a hot melt adhesive or a pressure sensitive hot melt adhesive) may be particularly advantageous as a laminate on a substrate in that the adhesive compositions may function as both the adhesive and the film (i.e., not requiring a second adhesive to adhere to a surface and cooling to a laminate form).

In some embodiments, the adhesive compositions in laminate form on a substrate may be produced by applying an adhesive composition melt (e.g., comprising a hot melt adhesive and a pressure sensitive hot melt adhesive) to the substrate (e.g., via melt casting); and allowing the adhesive composition melt to cool, thereby yielding the laminate on the substrate. In some embodiments, the adhesive composition in laminate form on a substrate may be smooth and non-tacky at room temperature. In some embodiments, the adhesive composition in laminate form on a substrate may be tacky at room temperature.

In some instances, a higher plasticizer concentration may be preferred in the adhesive composition melt to increase the flow of the adhesive composition melt at lower temperatures. An adhesive composition melt with increased flow may yield laminates with more uniform thickness and allow for thinner laminates. More uniform thicknesses provide for higher quality articles and, in some instances, higher clarity laminates.

Some embodiments may further involve treating the laminate to reduce the concentration of plasticizer in the laminate. Treating may involve drying, heating, applying vacuum, and the like, and any combination thereof. Reducing the concentration of the plasticizer may increase the stiffness and chemical resistance of the laminate.

Some embodiments may further involve treating the laminate to change surface chemistry of the laminate. For example, a caustic bath may be used to produce a laminate with a superhydrophilic surface.

In some embodiments, the adhesive compositions in laminate form on a substrate may have a thickness ranging from a lower limit of about 15 microns, 20 microns, 30 microns, 50 microns, or 100 microns to an upper limit of about 1200 microns, 800 microns, 500 microns, 400 microns, 300 microns, 200 microns, or 100 microns, and wherein the thickness may range from any lower limit to any upper limit and encompasses any subset therebetween. While these thicknesses may be preferred, one skilled in the art, with the benefit of this disclosure, should understand that the thicknesses described and not limiting to the structure of a laminate and thicknesses outside these ranges may be achieved.

In some embodiments, the adhesive compositions described herein (e.g., a hot melt adhesive and a pressure sensitive hot melt adhesive) may be in pellet form or molded shapes. In some embodiments, the adhesive compositions in pellet form or molded shapes may be tacky. In some embodiments, the adhesive compositions in pellet form or molded shapes may be smooth and substantially non-tacky at room temperature. The suitable amount of plasticizer in the adhesive compositions to achieve pellet form or molded shapes may depend on, inter alia, the degree of substitution of the starch derivative and/or cellulose derivatives, the composition of the starch derivative and/or cellulose derivatives, the molecular weight of the starch derivative and/or cellulose derivatives, the source of starch, composition and/or concentration of additives, and the composition of the plasticizers.

In some embodiments, the adhesive compositions described herein (e.g., a pressure sensitive adhesive) may be in a paste or putty form. In some embodiments, the adhesive compositions in a paste or putty form may be tacky. In some embodiments, the adhesive compositions in a paste or putty form may be smooth and substantially non-tacky. The suitable amount of plasticizer in the adhesive compositions to achieve a paste or putty form may depend on, inter alia, the degree of substitution of the starch derivative and/or cellulose derivatives, the composition of the starch derivative and/or cellulose derivatives, the molecular weight of the starch derivative and/or cellulose derivatives, the source of starch, composition and/or concentration of additives, and the composition of the plasticizers.

### IV. Articles Comprising Adhesive Compositions and Methods Relating Thereto

In some embodiments, an article may comprise a first surface having an adhesive composition described herein disposed thereon such that the adhesive composition is exposed to the local environment (e.g., a window tint, window film, light films, light filters, iron-on designs, laminate coatings on substrates, and the like).

In some embodiments, an article may comprise a first surface adhered to a second surface with an adhesive composition described herein. In some embodiments, at least one of the surfaces may be chosen so as to be releasable (e.g., a peelable layer) from the adhesive composition (e.g., an envelope with an adhesive between the paper and a release strip). In some embodiments, the first surface and the second surface may correspond to a first substrate and a second substrate, respectively. In some embodiments, the first surface and the second surface may correspond to a single substrate (e.g., a single piece of paper rolled into a cylinder and adhered to itself). In some embodiments, articles may be extended to three or more surfaces, including hundreds or thousands of surfaces (e.g., adhesive book bindings), without departing from the present invention.

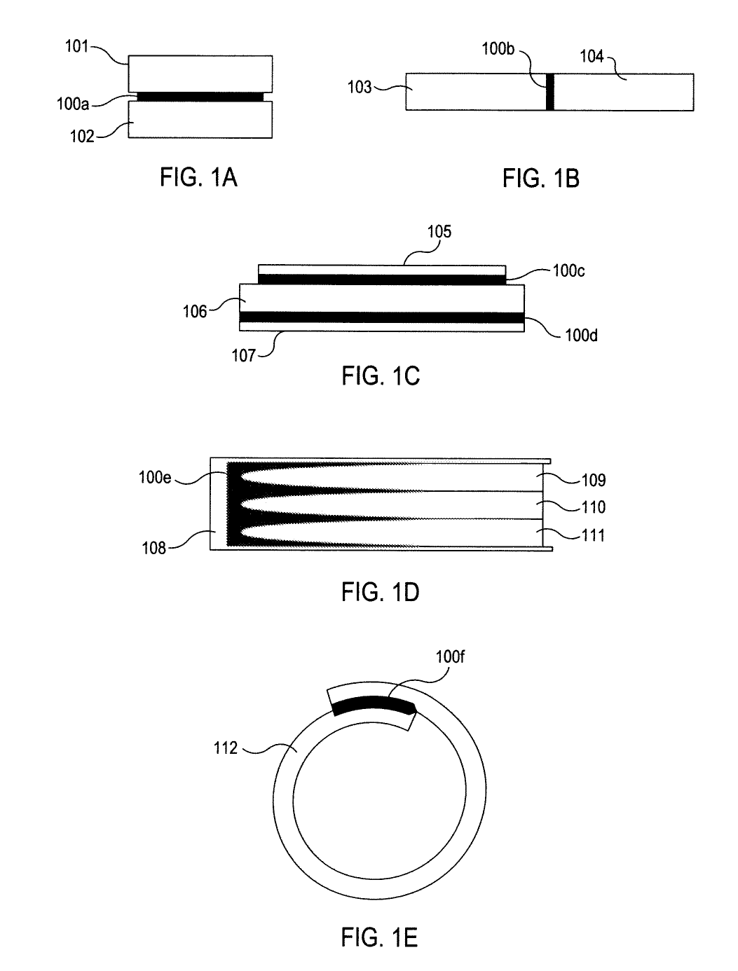

In some embodiments, the articles described herein may be designed with the first surface and the second surface adhered in any suitable configuration. Examples of suitable configurations may, in some embodiments, include, but are not limited to, those illustrated in FIG. 1. FIG. 1A illustrates a first substrate 101 and a second substrate 102 adhered together with an adhesive composition 100a in a stacked configuration. FIG. 1B illustrates a first substrate 103 and a second substrate 104 adhered together with an adhesive composition 100b in a side-by-side configuration. FIG. 1C illustrates a first substrate 105, a second substrate 106, and a third substrate 107 adhered together with an adhesive composition 100c,100d in a stacked configuration where each substrate 105,106,107 has different sizes. FIG. 1D illustrates a plurality of substrates in a hybrid configuration, wherein substrates 109,110,111 are each embedded at one end in an adhesive composition 100e which further adheres substrates 109,110,111 to substrate 108. FIG. 1E illustrates a substrate 112 rolled and adhered to itself at a seam with an adhesive composition 100f. One skilled in the art with the benefit of this disclosure should recognize that FIGS. 1A-1E are merely examples of possible configurations of articles described herein and that a multitude of other configurations are possible and within the bounds of this disclosure.

Exemplary examples of articles comprising adhesive compositions and at least one fibrous substrate (or surface) as described herein may, in some embodiments, include, but are not limited to, smoking articles (e.g., cigarettes), envelopes, tape, cardboard packaging (e.g., mailing packages and food containers like cereal boxes and frozen dinner containers), books, notebooks, magazines, sticky-notes, corrugated boxes, decorative boxes, paper bags, grocery bags, wrapping paper, wallpaper, paper honeycomb, emery boards, electric insulation paper, air filters, papier-mâché articles, carpets, dartboards, furniture or components thereof (e.g., carpet and/or fabric coated headboards, chairs, and stools), picture frames, medical garments (e.g., disposable gowns and surgical masks), diaper tabs, hygiene products (e.g., the adhesive strip on disposable feminine hygiene products or adhesives used to hold portions of a hygiene product together), self-adhesive labels, self-adhesive stamps, self-adhesive window covering films (e.g., protective films for glass or other substrates), self-adhesive window coverings (e.g., decorative window stickers, window films, and window tinting), heat activated films, light films, light filters, iron-on designs, substrates with laminated surfaces (e.g., laminated paper, laminated business cards, a laminated paper board, or a protective covering directly laminated onto a surface like glass), a coated substrate, and the like.

Substrates or surfaces suitable for use in conjunction with articles described herein may, in some embodiments, include, but are not limited to, fibers, woven fiber substrates, nonwoven fiber substrates, foamed substrates, solid substrates, and the like, any hybrid thereof, and any combination thereof.

Substrates or surfaces suitable for use in conjunction with articles described herein may, in some embodiments, comprise materials that include, but are not limited to, ceramics, natural polymers, synthetic polymers, metals, natural materials, carbons, and the like, and any combination thereof. Examples of ceramics may, in some embodiments, include, but are not limited to, glass, quartz, silica, alumina, zirconia, carbide ceramics, boride ceramics, nitride ceramics, and the like, and any combination thereof. Examples of natural polymers may, in some embodiments, include, but are not limited to, cellulose, starch, polylactic acid, polyhydroxyalkonates, polyhydroxybutyrates, and the like, any derivative thereof, and any combination thereof. Examples of synthetic polymers may, in some embodiments, include, but are not limited to, cellulose diacetate, cellulose triacetate, synthetic bamboo, rayon, acrylic, aramid, nylon, polyolefins, polyethylene, polypropylene (including biaxially oriented polypropylene substrates), polyethylene terephthalate, polyesters, polyamides, zylon, polyolefin copolymers (e.g., ethylene vinyl acetate), polysulfides, polyethers (including liquid crystalline polymer, polyoxomethylene), and the like, any derivative thereof, and any combination thereof. Examples of metals may, in some embodiments, include, but are not limited to, steel, stainless steel, aluminum, copper, and the like, any alloy thereof, and any combination thereof. Examples of natural materials may, in some embodiments, include, but are not limited to, wood, grass, animal hide, and the like, and any combination thereof. Examples of carbons may, in some embodiments, include, but are not limited to, carbon fibers, and the like, any derivative thereof, and any combination thereof.

Exemplary examples of substrates suitable for use in conjunction with the articles described herein may, in some embodiments, include, but are not limited to, paper, cardboard, card stock, sand paper, bond paper, wallpaper, wrapping paper, cotton paper, tipping paper, bleached paper, colored paper, construction paper, sisal paper, coated paper, wax paper, CLARIFOIL® (cellulose diacetate film, available from Celanese Corporation), woven fabrics, continuous filament nonwoven fabrics, carded nonwoven fabrics, tow, fiber bundles, twill, twine, rope, carpet, carpet backing, leather, animal hide, insulation, wood and/or grass derived substrates (e.g., wood veneers, particle board, fiberboard, medium-density fiberboard, high-density fiberboard, oriented strand board, cork, hardwoods (e.g., balsa wood, beech, ash, birch, Brazil wood, cherry, chestnut, elm, hickory, mahogany, maple, oak, rosewood, teak, walnut, locust, mango, alder, and the like), softwoods (e.g., pine, fir, spruce, cedar, hemlock, and the like), rough lumber, finished lumber, natural fibrous material, and bamboo), foam substrates (e.g., memory foams, polymer foams, polystyrene foam, polyurethane foam, frothed polyurethane, and soy-based foams), frothed polyurethane, and soy-based foams), and the like, and any combination thereof.

By way of nonlimiting example, an article (e.g., a cigarette paper or a paper towel roll) may comprise two surfaces of a single substrate (e.g., a tipping paper or a cardboard) adhered together (e.g., at a seam line) with the adhesive compositions described herein (e.g., a hot melt adhesive or a pressure sensitive hot melt adhesive).

By way of another nonlimiting example, an article (e.g., a cardboard container for shipping or containing food) may comprise two surfaces adhered together with the adhesive compositions described herein (e.g., a hot melt adhesive, a pressure sensitive hot melt adhesive, or a pressure sensitive adhesive).

By way of yet another nonlimiting example, an article (e.g., a food container) may comprise two surfaces (e.g., a cardboard container and a cellulose diacetate film (like CLARIFOIL®)) adhered together with the adhesive compositions described herein (e.g., a hot melt adhesive, a pressure sensitive hot melt adhesive, or a pressure sensitive adhesive).

By way of another nonlimiting example, an article (e.g., window tints or window coverings) may comprise a first surface (e.g., a polyester film) with the adhesive compositions described herein (e.g., a pressure sensitive hot melt adhesive or a pressure sensitive adhesive) disposed thereon so as to allow for adherence to a second surface (e.g., a glass surface or other similar transparent surface). In some embodiments, the article may comprise, in order, the first surface, the adhesive compositions, and a peelable layer that can be removed before adherence to the second surface. In some embodiments, the article may comprise adhesive compositions that are smooth and substantially non-tacky at room temperature such that a peelable layer is not required and the adhesive compositions may be exposed to air. In such embodiments, heat may be used in adhering the first surface to the second surface.

By way of yet another nonlimiting example, an article (e.g., an iron-on design or laminated card) may comprise a surface or substrate (e.g., paper, a fabric, or a polymer film) with the adhesive compositions disposed thereon (e.g., a hot melt adhesive or a pressure sensitive hot melt adhesive). In some instances, the article may then be adhered to another surface (e.g., applying heat so as to adhere an iron-on design to another surface like a piece of clothing or other fabric). In some embodiments, the article may be formed by applying an adhesive melt to the surface or substrate and allowing the adhesive melt to cool so as to form a laminate on the surface or substrate.

By way of nonlimiting example, an article (e.g. a labelled bottle) may comprise a first surface (e.g., a plastic or glass container) to which an adhesive described herein may be applied for use in adhering a second surface (e.g., a paper label, a plastic label, or a CLARIFOIL® label) to the first surface. In some instances, the adhesive described herein may be on the second surface before application to the first surface. The adhesive described herein may have unique advantages in relation to recycling of the bottles. For example, the components of at least some of the adhesive described herein may be compatible with the current plastic recycling technologies (which allows for a 100% recyclable bottle) and glass bottle washing technologies (which allows for labels to be removed without additional steps and cost).

Some embodiments may involve applying an adhesive compositions described herein to a surface. In some embodiments, applying may involve heating the adhesive compositions and/or applying pressure to the adhesive compositions (e.g., melt casting a laminate onto a surface). In some embodiments, applying the adhesive composition may be in a high-speed application (e.g., about 50 m/min or greater or about 200 m/min or greater).

Some embodiments may involve adhering two or more surfaces together using adhesive compositions described herein. In some embodiments, adhering may involve heating the adhesive compositions and/or applying pressure to the adhesive compositions. In some embodiments, adhering two or more surfaces together using an adhesive composition may be in a high-speed application (e.g., about 50 m/min or greater or about 200 m/min or greater).

In some embodiments, adhering surfaces together may involve heating an adhesive composition described herein to yield an adhesive melt; applying the adhesive melt to a first surface; and adhering a second surface to the first surface with the adhesive optionally with the application of pressure.

In some embodiments wherein an adhesive composition described herein is tacky, adhering surfaces together may involve applying the adhesive composition to a first surface; and adhering a second surface to the first surface with the adhesive composition optionally with the application of heat and/or pressure.

In some embodiments, adhering surfaces together may involve disposing an adhesive sheet between a first surface and a second surface; and heating the adhesive sheet so as to adhere the first surface and the second surface together.

Embodiments disclosed herein include:

A. a hot melt adhesive composition as defined herein that includes a starch derivative; and a plasticizer in an amount of about 5% to about 60% by weight of the hot melt adhesive composition, wherein the adhesive is non-tacky at room temperature;

B. a pressure sensitive hot melt adhesive composition as defined herein that includes a starch derivative; and a plasticizer in an amount of about 15% to about 75% by weight of the pressure sensitive hot melt adhesive; and

C. a pressure sensitive adhesive composition as defined herein that includes a starch derivative; a plasticizer in an amount of about 40% to about 90% by weight of the pressure sensitive adhesive composition.

Each of embodiments A, B, and C may have one or more of the following additional elements in any combination: Element 1: the adhesive composition further comprising a cellulose derivative at a concentration of about 0.02% to about 65% by weight of the adhesive composition; Element 2: wherein the starch derivative has a degree of substitution of about 0.5 to about 3; Element 3: wherein the starch derivative comprises at least one ester substituent selected from the group consisting of a C₁-C₂₀ aliphatic ester, a functional C₁-C₂₀ aliphatic ester, acetate, propionate, butyrate, an aromatic ester, a substituted aromatic ester, any derivative thereof, and any combination thereof; Element 4: wherein the starch derivative comprises at least one ether substituent selected from the group consisting of methylether, ethylether, propylether, hydroxypropylether, hydroxyethylether, hydroxyethyl methylether, hydroxypropyl methylether, carboxymethylether, and any combination thereof; Element 5: wherein the plasticizer is a food-grade plasticizer; Element 6: wherein the plasticizer is a an aroma; Element 7: wherein the adhesive composition is at least 50% bio-derived; Element 8: wherein the adhesive composition is at least 90% bio-derived; Element 9: wherein the adhesive composition has a glass transition temperature of about −100° C. to about 190° C.; Element 10: wherein the adhesive composition has no detectible glass transition temperature; Element 11: wherein the adhesive composition has a melt flow index of about 0 g/10 min at 125° C./500 g to about 150 g/10 min at 125° C./500 g; Element 12: wherein the adhesive composition has a peel adhesion of about 0.1 lb/in to about 25 lb/in with a 4 mil coated paper backing and a 24 hr dwell; Element 13: wherein the adhesive composition a 72-hr percent increase in peel adhesion of about 3% to about 300%; Element 14: wherein the adhesive composition has a lap shear strength of about 0.2 kgf to about 17 kgf with a 4 mil coated paper; Element 15: wherein the adhesive composition has a lap shear strength of about 0.2 kgf to about 30 kgf with an aluminum substrate; Element 16: wherein the adhesive composition degrades by about 5% to about 2000% more than a cellulose diacetate material plasticized with 20% triacetin as measured according to EN13432; and Element 17: wherein the adhesive composition has a haze of about 3 to about 100.

By way of non-limiting example, exemplary combinations applicable to A, B, C include: at least two of Elements 2-4; Element 5 in combination with Element 6; at least one of Elements 5-6 in combination with at least one of Element 2-4; at least one of Elements 9-17 in combination with the foregoing; at least one of Elements 9-17 in combination with at least one of Element 1-6; one of Elements 7-8 in combination with the foregoing; Element 1 in combination with the foregoing; and Element 1 in combination with one of Elements 2-4.

Additional Embodiments disclosed herein include:

D. an article comprising a substrate and at least one adhesive composition according to Embodiments A-C optionally in combination with at least one of Elements 1-17;

E. a method that includes heating the adhesive composition according to Embodiments A or B optionally in combination with at least one of Elements 1-17; applying the melt to a first surface; and adhering the first surface to a second surface;

F. a method that includes heating the adhesive composition according to Embodiments A or B optionally in combination with at least one of Elements 1-17; applying the melt to a surface; and allowing the melt on the surface to cool so as to yield a laminate on the surface;

G. a method that includes applying the adhesive composition according to Embodiment B optionally in combination with at least one of Elements 1-17; contacting the adhesive composition on the first surface with a second surface; and applying pressure and optionally heat to adhere the first and second surfaces; and

H. a method that includes applying the adhesive composition according to Embodiment C optionally in combination with at least one of Elements 1-17; and adhering the first surface to a second surface, optionally with the application of pressure.

To facilitate a better understanding of the present invention, the following examples of preferred or representative embodiments are given. In no way should the following examples be read to limit, or to define, the scope of the invention.

### Examples

### Example 1

Starch acetate samples were prepared by reacting starch from various sources with acetic acid, acetic anhydride, and phosphoric acid at 85° C. to 115° C. for 2 hours. The samples were then precipitated in water, filtered, washed with water, and then dried overnight at 85° C. The molecular weight and acetyl value were measured and are presented in Table 1.

TABLE 1

| Starch Source | MW (g/mol) | Degree of Substitution |
|---|---|---|
| dent corn 1 | ~16,000 | ~2.9 |
| dent corn 2 | ~26,000 | ~2.8 |
| dent corn 3 | ~10,000 | ~2.8 |
| dent corn 4 | ~3,800 | ~2 |
| waxy rice | ~8,000 | ~3 |
| waxy corn | ~30,000 | ~2.9 |
| tapioca | ~25,000 | ~2.8 |

### Example 2

The dent corn 1 derived starch acetate from Example 1 was compounded with triacetin and a cellulose acetate according to Table 2. The melt flow index (“MFI”) for the samples was measured with a 100 g weight at 125° C. with a 300 sec melt time.

TABLE 2

| | Wt % Starch | Wt % Cellulose | | MFI |
|---|---|---|---|---|
| Sample | Acetate | Acetate | Wt % Triacetin | (g/10 min) |
| PSE-1 | 40 | 0 | 60 | 400 |
| PSE-2 | 50 | 0 | 50 | 145 |
| PSE-3 | 30 | 10 | 60 | 195 |
| PSE-4 | 20 | 20 | 60 | 91 |
| PSE-5 | 10 | 30 | 60 | 44 |
| PSE-6 | 4 | 36 | 60 | 15 |
| Cellulose | 0 | 40 | 60 | 6 |
| Ester | | | | |
| Control | | | | |

### Example 3

The dent corn 1 derived starch acetate from Example 1 was compounded with triacetin according to Table 3. The melt flow index (“MFI”) for the samples was measured with a 500 g weight at 125° C. with a 300 sec melt time.

TABLE 3

| | Wt % Starch | Wt % | MFI |
|---|---|---|---|
| Sample | Acetate | Triacetin | (g/10 min) |
| PSE-7 | 60 | 40 | 70 |
| PSE-8 | 65 | 35 | 20 |

### Example 4

The dent corn 1 derived and waxy corn derived starch acetates from Example 1 were compounded with triacetin and a cellulose acetate according to Table 4. The melt flow index (“MFI”) for the samples was measured with a 100 g weight at 125° C. with a 300 sec melt time.

TABLE 4

| | Wt % Starch | Wt % Cellulose | Wt % | MFI |
|---|---|---|---|---|
| Sample | Acetate | Acetate | Triacetin | (g/10 min) |
| PSE-9 | 20 (waxy) | 20 | 60 | >98 |
| PSE-10 | 20 (dent-1) | 20 | 60 | 91 |

### Example 5

The dent corn 1 derived starch acetate from Example 1 was compounded with triacetin and a cellulose acetate and optionally with additional fillers according to Table 5. The melt flow index (“MFI”) for the samples was measured with a 100 g weight at 125° C. with a 300 sec melt time.

TABLE 5

| | Wt % | Wt % | | | |
|---|---|---|---|---|---|
| | Starch | Cellulose | Wt % | Additional Wt % | MFI |
| Sample | Acetate | Acetate | Triacetin | Filler | (g/10 min) |
| PSE-4 | 20 | 20 | 60 | — | 91 |
| PSE-4a | 20 | 20 | 60 | 2% NCC | 80 |
| PSE-3 | 30 | 10 | 60 | — | 195 |
| PSE-3a | 30 | 10 | 60 | 2% NCC | 135 |
| PSE-1 | 40 | — | 60 | — | 400 |
| PSE-1a | 40 | — | 60 | 2% NCC | 275 |
| PSE-2 | 50 | — | 50 | — | 145 |
| PSE-2a | 50 | — | 50 | 2% corn starch | 120 |
| | | | | (underivatized) | |
| PSE-2b | 50 | — | 50 | 5% corn starch | 59 |
| | | | | (underivatized) | |
| PSE-2c | 50 | — | 50 | 2% glass beads | 110 |
| PSE-2d | 50 | — | 50 | 2% NCC | 71 |

### Example 6

The adhesive compositions on Table 5 were tested for peel adhesion by ASTM 3330/D Method A (180° Peel) after a 24 hour dwell time conditioned at 22° C. and 60% relative humidity. The adhesive strength was measured on stainless steel, glass, and corrugated cardboard and is presented in Table 6.

TABLE 6

| | 180° Peel | | |
|---|---|---|---|
| | Corrugated | 180° Peel | |
| | Cardboard | Stainless Steel | 180° Peel Glass |
| | Substrate | Substrate | Substrate |
| Sample | Mean (lbf/in) | Mean (lbf/in) | Mean (lbf/in) |
| PSE-1 | 0.7056 | — | — |
| PSE-2 | 3.9518 | 3.4662 | 4.06 |
| PSE-2a | 4.7394 | 3.6978 | 3.63 |
| PSE-2b | 3.1349 | 3.6658 | — |
| PSE-2c | 4.4970 | 3.9655 | 4.57 |
| PSE-2d | 2.4097 | 3.5591 | — |

### Example 7

Two dent corn-derived starch acetates (SA-1 and SA-2) were compounded with several plasticizers in the amounts and compositions detailed in Tables 7-9. The physical properties of the resultant samples were analyzed via DSC with TA Instruments DSC Q2000. The samples were cycled twice from −90° C. to 200° C. with a ramp rate of 5° C./min. The glass transition temperature (Tg), the cold crystallization temperature, and the melting temperature were measured on the second heating cycle. The results for PSE-1 and PSE-2 are presented in Table 8 and 9, respectively, where “ND” refers to no detectable measurement.

TABLE 7

| Starch Acetate | Degree of | MW | Wt % |
|---|---|---|---|
| Composition | Substitution | (g/mol) | Plasticizer |
| SA-1 | about 2 | 3,800 | 50 |
| SA-2 | about 3 | 16,000 | 50 |

TABLE 8
Adhesive Compositions with SA-1

| | T_{g} | Cold Crystallization | Melting Temperature |
|---|---|---|---|
| Plasticizer | (° C.) | Temperature (° C.) | (° C.) |
| alpha-pinene | 91 | ND | 150 |
| citral | 43 | ND | ND |
| diacetin | −66 | ND | ND |
| | 11 | | |
| dimethyl adipate | −38 | −4 | 8 |
| dibutyl tartrate | −34 | ND | ND |
| PEG 300 | −64 | ND | ND |
| PEG DGE | −53 | ND | ND |
| resorcinol | −28 | ND | ND |
| monoacetate | | | |
| triacetin | −53 | ND | ND |
| | 45 | | |
| tributyl-o-acetyl | 96 | ND | ND |
| citrate | | | |
| tributylphosphate | 14 | ND | ND |
| triethyl citrate | −50 | ND | ND |
| cinnamyl alcohol | −41 | ND | ND |
| eugenol | −51 | ND | ND |

TABLE 9
Adhesive Compositions with SA-2

| | T_{g} | Cold Crystallization | Melting Temperature |
|---|---|---|---|
| Plasticizer | (° C.) | Temperature (° C.) | (° C.) |
| cinnamyl alcohol | −61 | ND | ND |
| | −39 | | |
| | 17 | | |
| citral | 105 | ND | ND |
| diacetin | −63 | ND | ND |
| dibutyl tartrate | −63 | ND | ND |
| | 131 | | |
| dimethyl adipate | −49 | −27 | ND |
| | 130 | | |
| eugenol | −59 | ND | ND |
| glyceryl | −63 | ND | ND |
| trypropionin | | | |
| gamma- | −12 | ND | ND |
| valerolactone | | | |
| propylene | ND | ND | 148 |
| carbonate | | | 172 |
| resorcinol | −30 | ND | ND |
| monoacetate | | | |
| triacetin | −58 | ND | ND |
| triethyl citrate | −57 | ND | ND |

It was observed that alpha-pinene, PEG 300, PED DGE, tributyl phosphate, and tributyl o-acetyl did not fully plasticize the PSE-2 sample.

### Example 8

A plurality of adhesive compositions were prepared by compounding starch acetate sample dent corn 4 from Example 1, cellulose acetate (a degree of substitution of about 2.4 and a MW of about 44,000 g/mol), and triacetin as described in Table 10. The glass transition temperatures of the samples were measured as described in Example 7 and are also presented in Table 10.

TABLE 10

| Wt % Starch | Wt % Cellulose | Wt % | T_{g}¹ |
|---|---|---|---|
| Acetate | Acetate | Triacetin | (° C.) |
| — | 100 | — | 167-207² |
| 100 | — | — | 130 |
| 4 | 36 | 60 | −53 |
| 10 | 30 | 60 | −56 |
| 20 | 20 | 60 | −58 |
| 30 | 10 | 60 | −62 |
| 40 | 0 | 60 | −62 |

¹Glass transition temperature as measured by TA Instruments DSC Q2000.
²Literature values for cellulose acetate.

### Example 9

The 180° peel test on stainless steel substrates was performed with three adhesive compositions with dwell times of 24 hours and 72 hours. Three adhesive compositions were tested for peel adhesion by ASTM 3330/D Method A (180° Peel) after (1) a 24 hour dwell time and (2) a 72 hour dwell time conditioned at 22° C. and 60% relative humidity. The results provided in Table 11 illustrate that the adhesive strength of the adhesive compositions increases over time.

TABLE 11

| | 180° Peel | 180° Peel |
|---|---|---|
| | Stainless Steel | Stainless Steel |
| | Substrate 24 hr. | Substrate 72 hr. |
| | Dwell Time | Dwell Time |
| Sample | Mean (lbf/in) | Mean (lbf/in) |
| PSE-2 | 3.47 | 4.39 |
| PSE-2b | 3.67 | 5.41 |
| PSE-2c | 3.97 | 4.17 |

### Example 10

This example demonstrates the use of various plasticizers (including amines) in the starch derivative adhesives described herein. A starch acetate was prepared to a degree of substitution of about 2.8 to about 2.9 by reacting industrial corn starch with acetic acid, acetic anhydride, and sulfuric acid, then precipitated, filtered, washed with water, and dried overnight at 85° C. The starch acetate was then used in preparing several samples according to Table 12, which also includes the measured glass transition temperatures as described in Example 7.

TABLE 12

| | Wt % | Plasticizer | T_{g} |
|---|---|---|---|
| Sample | Plasticizer | Composition | (° C.) |
| PSE-11 | 62 | 92:8 diacetin to | −65 |
| | | acetylsalicylic acid | |
| PSE-12 | 62 | 92:8 diacetin to butylated | −66 |
| | | hydroxyanisol | |
| PSE-13 | 62 | 92:8 diacetin to butylated | −65 |
| | | hydroxytoluene | |
| PSE-14 | 62 | 92:8 diacetin to benzoic acid | −66 |
| PSE-15 | 62 | 92:8 diacetin to salicylic acid | −72 |
| PSE-16 | 62 | 92:8 diacetin to imidazole | −60 |

### Example 11

This example demonstrates the use of various plasticizers (including amines) in varying amounts in the starch derivative adhesives described herein. The starch acetate from Example 10 was then used in preparing several samples according to Tables 13-15, which also includes the measured glass transition temperatures as described in Example 7.

TABLE 13

| | Wt % Starch | Wt % | Wt % Acetylsalicylic | T_{g} |
|---|---|---|---|---|
| Sample | Acetate | Diacetin | Acid | (° C.) |
| PSE-17 | 40% | 60% | 0% | −65 |
| PSE-18 | 40% | 0% | 60% | −5 |
| PSE-19 | 38% | 57% | 5% | −65 |
| PSE-20 | 34% | 33% | 33% | −58 |
| PSE-21 | 34% | 49.5% | 16.5% | −67 |
| PSE-22 | 34% | 16.5% | 49.5% | −53 |

TABLE 14

| | Wt % Starch | Wt % | | T_{g} |
|---|---|---|---|---|
| Sample | Acetate | Diacetin | Wt % Triethylcitrate | (° C.) |
| PSE-17 | 40% | 60% | 0% | −65 |
| PSE-23 | 40% | 0% | 60% | −59 |
| PSE-24 | 40% | 30% | 30% | −62 |

TABLE 15

| | Wt % Starch | Wt % | | T_{g} |
|---|---|---|---|---|
| Sample | Acetate | Diacetin | Wt % Imidazole | (° C.) |
| PSE-25 | 40% | 0% | 60% | −53 |
| PSE-16 | 38% | 57% | 5% | −60 |

### Example 12

This example demonstrates the effect of tackifiers on the properties of the starch derivative adhesives described herein. The starch acetate from Example 10 was then used in preparing several samples according to Tables 16 using tackifiers (terpene phenolic resins, SYLVARES™ TP2040 and rosin esters, SYLVALITE™ RE 100XL, available from Arizona Chemical) which also includes the measured glass transition temperatures as described in Example 7.

TABLE 16

| | Wt % Starch | Wt % | | T_{g} |
|---|---|---|---|---|
| Sample | Acetate | Diacetin | Wt % Tackifier | (° C.) |
| PSE-17 | 40% | 60% | 0% | −65 |
| PSE-26 | 38% | 57% | 5 wt % | −65 |
| | | | SYLVARES ™ TP2040 | |
| PSE-27 | 34% | 51% | 15 wt % | −67 |
| | | | SYLVARES ™ TP2040 | |
| PSE-28 | 38% | 57% | 5 wt % SYLVALITE ™ | −67 |
| | | | RE 100XL | |
| PSE-29 | 34% | 51% | 15 wt % SYLVALITE ™ | −69 |
| | | | RE 100XL | |

### Example 13

This example demonstrates the effect of nonionic surfactants on the properties of the starch derivative adhesives described herein. A plurality of adhesive samples were prepared by compounding starch acetate of Example 10, a plasticizer, tackifiers, and surfactant in the amounts and compositions detailed in Table 17. The characteristics of the adhesive samples were measured and are reported in Table 17.

TABLE 17

| | | | | T_{g} |
|---|---|---|---|---|
| Sample | Plasticizer | Tackifier | Surfactant | (° C.) |
| PSE-30 | 37.62 wt % | 25 wt % SYLVALITE ™ | 5 wt % | −64 |
| | diacetin | RE 100XL | BRIJ L23 | |
| | | | (30% (w/v) in H₂O) | |
| PSE-31 | 37.62 wt % | 25 wt % SYLVALITE ™ | 5 wt % | −62 |
| | diacetin | RE 100XL | SIDERCEL SF 140 | |
| PSE-32 | 37.62 wt % | 25 wt % SYLVALITE ™ | 5 wt % | −64 |
| | diacetin | RE 100XL | TRITON X-100 | |
| PSE-33 | 37.62 wt % | 25 wt % SYLVALITE ™ | 5 wt % | −67 |
| | diacetin | RE 100XL | POLYFOX PF-151N | |
| PSE-34 | 37.62 wt % | 25 wt % SYLVALITE ™ | 5 wt % | −57 |
| | diacetin | RE 100XL | GLYCOSPERSE L- | |
| | | | 20 KFG | |

The above examples illustrate the plurality of adhesive compositions that may be produced with starch derivatives, plasticizers, optionally cellulose derivatives, and optionally additives like fillers. Further, these examples illustrate the ability to tailor the characteristics of the adhesive compositions with changes in the components of the adhesive composition and their relative concentrations.

Embodiments described in the present application include Embodiments A, B, C, and D:

### Embodiment A

A hot melt adhesive composition comprising a starch derivative; and a plasticizer in an amount of about 5% to about 60% by weight of the hot melt adhesive composition, wherein the adhesive is non-tacky at room temperature.

### Embodiment B

A pressure sensitive hot melt adhesive composition comprising a starch derivative; and a plasticizer in an amount of about 15% to about 75% by weight of the pressure sensitive hot melt adhesive.

### Embodiment C

A pressure sensitive adhesive composition comprising a starch derivative; a plasticizer in an amount of about 40% to about 90% by weight of the pressure sensitive adhesive composition

### Embodiment D

A pressure sensitive adhesive composition comprising a starch derivative; and a plasticizer in an amount of about 5% to about 90% by weight of the hot melt adhesive composition and a cellulose derivative at a concentration of about 0.02% to about 65% by weight of the adhesive composition.

Each of embodiments A, B, C, and D may include one or more of the following elements, in any combination:

Element 1: The composition wherein the adhesive composition further comprising a cellulose derivative at a concentration of about 0.02% to about 65% by weight of the adhesive composition.

Element 2: The composition wherein the adhesive composition further comprising a polyolefin, ethylene copolymers, a thermoplastic polyurethane, an acrylic acid polymer, polytetrafluoroethylene, an ethylene vinyl acetate copolymer derivative, a polyester, a polysiloxane, polybutadiene, polyisoprene, poly(methacrylate), poly(methyl methacrylate), a styrene-butadiene-styrene block copolymer, poly(hydroxyethylmethacrylate), poly(vinyl chloride), poly(vinyl acetate), a polyether, a polyacrylonitrile, a polyethylene glycol, polymethylpentene, polybutadiene, polyhydroxy alkanoates, poly(lactic acid), poly(glycolic acid), acrylic acid-based polymers, a methacrylic acid based polymer, a polyanhydride, a polyorthoester, cross-linked poly(vinyl alcohol), neoprene rubber, butyl rubber, polyvinyl acetate phthalate, polyvinyl acetate, shellac, zein, polyethylene oxide, ethylene oxide-propylene oxide copolymers, polyethylene-polypropylene glycol, carbomer, polycarbophil, chitosan, polyvinyl pyrrolidone, poly(vinyl alcohol), a polyethyleneimine, a polyacrylate, a polyacrylamide, a polymethacrylamide, a polyphosphazine, a polyoxazolidine, a polyhydroxyalkylcarboxylic acid, an alginic acid, natural gums, povidone, gelatin, any derivative thereof, any copolymer thereof, any blend polymer thereof, and any combination thereof

Element 3: The composition wherein the adhesive composition, wherein the plasticizer comprises two or more plasticizers.

Element 4: The composition wherein the adhesive composition, wherein the plasticizer comprises a nonionic surfactant.

By way of example, Embodiment A, B, or C may be combined with Elements 1 and 2; Embodiment A, B, or C may be combined with Elements 1 and 2; Embodiment A, B, C or D may be combined with Elements 2, 3, and 4; Embodiment A, B, or C may be combined with Elements 1, 2, and 4; or Embodiment A, B, C, or D may be combined with Elements 2 and 4; etc.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A hot melt adhesive composition comprising a starch derivative; and a plasticizer in an amount of about 5% to about 60% by weight of the hot melt adhesive composition, wherein the adhesive is non-tacky at room temperature.

2. The hot melt adhesive composition of claim 1 further comprising a cellulose derivative at a concentration of about 0.02% to about 65% by weight of the adhesive composition.

3. The hot melt adhesive composition of claim 1 further comprising a polyolefin, ethylene copolymers, a thermoplastic polyurethane, an acrylic acid polymer, polytetrafluoroethylene, an ethylene vinyl acetate copolymer derivative, a polyester, a polysiloxane, polybutadiene, polyisoprene, poly(methacrylate), poly(methyl methacrylate), a styrene-butadiene-styrene block copolymer, poly(hydroxyethylmethacrylate), poly(vinyl chloride), poly(vinyl acetate), a polyether, a polyacrylonitrile, a polyethylene glycol, polymethylpentene, polybutadiene, polyhydroxy alkanoates, poly(lactic acid), poly(glycolic acid), acrylic acid-based polymers, a methacrylic acid based polymer, a polyanhydride, a polyorthoester, cross-linked poly(vinyl alcohol), neoprene rubber, butyl rubber, polyvinyl acetate phthalate, polyvinyl acetate, shellac, zein, polyethylene oxide, ethylene oxide-propylene oxide copolymers, polyethylene-polypropylene glycol, carbomer, polycarbophil, chitosan, polyvinyl pyrrolidone, poly(vinyl alcohol), a polyethyleneimine, a polyacrylate, a polyacrylamide, a polymethacrylamide, a polyphosphazine, a polyoxazolidine, a polyhydroxyalkylcarboxylic acid, an alginic acid, natural gums, povidone, gelatin, any derivative thereof, any copolymer thereof, any blend polymer thereof, and any combination thereof.

4. The hot melt adhesive composition of claim 1, wherein the plasticizer comprises two or more plasticizers.

5. The hot melt adhesive composition of claim 1, wherein the plasticizer comprises a nonionic surfactant.

6. A pressure sensitive hot melt adhesive composition comprising a starch derivative; and a plasticizer in an amount of about 15% to about 75% by weight of the pressure sensitive hot melt adhesive.

7. The pressure sensitive hot melt adhesive composition of claim 6, wherein the adhesive composition further comprising a cellulose derivative at a concentration of about 0.02% to about 65% by weight of the adhesive composition.

8. The pressure sensitive hot melt adhesive composition of claim 6, wherein the adhesive composition further comprising a polyolefin, ethylene copolymers, a thermoplastic polyurethane, an acrylic acid polymer, polytetrafluoroethylene, an ethylene vinyl acetate copolymer derivative, a polyester, a polysiloxane, polybutadiene, polyisoprene, poly(methacrylate), poly(methyl methacrylate), a styrene-butadiene-styrene block copolymer, poly(hydroxyethylmethacrylate), poly(vinyl chloride), poly(vinyl acetate), a polyether, a polyacrylonitrile, a polyethylene glycol, polymethylpentene, polybutadiene, polyhydroxy alkanoates, poly(lactic acid), poly(glycolic acid), acrylic acid-based polymers, a methacrylic acid based polymer, a polyanhydride, a polyorthoester, cross-linked poly(vinyl alcohol), neoprene rubber, butyl rubber, polyvinyl acetate phthalate, polyvinyl acetate, shellac, zein, polyethylene oxide, ethylene oxide-propylene oxide copolymers, polyethylene-polypropylene glycol, carbomer, polycarbophil, chitosan, polyvinyl pyrrolidone, poly(vinyl alcohol), a polyethyleneimine, a polyacrylate, a polyacrylamide, a polymethacrylamide, a polyphosphazine, a polyoxazolidine, a polyhydroxyalkylcarboxylic acid, an alginic acid, natural gums, povidone, gelatin, any derivative thereof, any copolymer thereof, any blend polymer thereof, and any combination thereof.

9. The pressure sensitive hot melt adhesive composition of claim 6, wherein the plasticizer comprises two or more plasticizers.

10. The pressure sensitive hot melt adhesive composition of claim 6, wherein the plasticizer comprises a nonionic surfactant.

11. A pressure sensitive adhesive composition comprising a starch derivative; a plasticizer in an amount of about 40% to about 90% by weight of the pressure sensitive adhesive composition.

12. The pressure sensitive adhesive composition of claim 11 further comprising a cellulose derivative at a concentration of about 0.02% to about 59% by weight of the pressure sensitive adhesive composition.

13. The pressure sensitive adhesive composition of claim 11 further comprising a polyolefin, ethylene copolymers, a thermoplastic polyurethane, an acrylic acid polymer, polytetrafluoroethylene, an ethylene vinyl acetate copolymer derivative, a polyester, a polysiloxane, polybutadiene, polyisoprene, poly(methacrylate), poly(methyl methacrylate), a styrene-butadiene-styrene block copolymer, poly(hydroxyethylmethacrylate), poly(vinyl chloride), poly(vinyl acetate), a polyether, a polyacrylonitrile, a polyethylene glycol, polymethylpentene, polybutadiene, polyhydroxy alkanoates, poly(lactic acid), poly(glycolic acid), acrylic acid-based polymers, a methacrylic acid based polymer, a polyanhydride, a polyorthoester, cross-linked poly(vinyl alcohol), neoprene rubber, butyl rubber, polyvinyl acetate phthalate, polyvinyl acetate, shellac, zein, polyethylene oxide, ethylene oxide-propylene oxide copolymers, polyethylene-polypropylene glycol, carbomer, polycarbophil, chitosan, polyvinyl pyrrolidone, poly(vinyl alcohol), a polyethyleneimine, a polyacrylate, a polyacrylamide, a polymethacrylamide, a polyphosphazine, a polyoxazolidine, a polyhydroxyalkylcarboxylic acid, an alginic acid, natural gums, povidone, gelatin, any derivative thereof, any copolymer thereof, any blend polymer thereof, and any combination thereof.

14. The pressure sensitive adhesive composition of claim 11, wherein the plasticizer comprises two or more plasticizers.

15. The pressure sensitive adhesive composition of claim 11, wherein the plasticizer comprises a nonionic surfactant.

16. A pressure sensitive adhesive composition comprising a starch derivative; and a plasticizer in an amount of about 5% to about 90% by weight of the hot melt adhesive composition and a cellulose derivative at a concentration of about 0.02% to about 65% by weight of the adhesive composition.

17. The pressure sensitive adhesive composition of claim 16 further comprising a polyolefin, ethylene copolymers, a thermoplastic polyurethane, an acrylic acid polymer, polytetrafluoroethylene, an ethylene vinyl acetate copolymer derivative, a polyester, a polysiloxane, polybutadiene, polyisoprene, poly(methacrylate), poly(methyl methacrylate), a styrene-butadiene-styrene block copolymer, poly(hydroxyethylmethacrylate), poly(vinyl chloride), poly(vinyl acetate), a polyether, a polyacrylonitrile, a polyethylene glycol, polymethylpentene, polybutadiene, polyhydroxy alkanoates, poly(lactic acid), poly(glycolic acid), acrylic acid-based polymers, a methacrylic acid based polymer, a polyanhydride, a polyorthoester, cross-linked poly(vinyl alcohol), neoprene rubber, butyl rubber, polyvinyl acetate phthalate, polyvinyl acetate, shellac, zein, polyethylene oxide, ethylene oxide-propylene oxide copolymers, polyethylene-polypropylene glycol, carbomer, polycarbophil, chitosan, polyvinyl pyrrolidone, poly(vinyl alcohol), a polyethyleneimine, a polyacrylate, a polyacrylamide, a polymethacrylamide, a polyphosphazine, a polyoxazolidine, a polyhydroxyalkylcarboxylic acid, an alginic acid, natural gums, povidone, gelatin, any derivative thereof, any copolymer thereof, any blend polymer thereof, and any combination thereof.

18. The pressure sensitive adhesive composition of claim 16, wherein the plasticizer comprises two or more plasticizers.

19. The pressure sensitive adhesive composition of claim 16, wherein the plasticizer comprises a nonionic surfactant.
